(19) United States
(12) Patent Application Publication
(10) Pub. No.: US 2026/0320406 A1
(43) Pub. Date: Oct. 15, 2026

(54) REINFORCEMENT LEARNING METHOD, APPARATUS, AND COMPUTER-READABLE MEDIUM FOR OPTIMIZING A CURRENT VALUE OF A CONTENT ATTRIBUTE

(71) Applicant: Zzazz Inc., New York, NY (US)

(72) Inventors: Illan Poreh, New York, NY (US); Madhusudhanan Krishnamoorthy, Bangalore (IN); Chaikesh Chouragade, Bangalore (IN)

(21) Appl. No.: 19/704,147

(22) Filed: Jun. 10, 2026

Related U.S. Application Data
(63) Continuation-in-part of application No. 19/299,162, filed on Aug. 13, 2025.
(63) Continuation-in-part of application No. 19/299,185, filed on Aug. 13, 2025.
(60) Provisional application No. 63/682,381, filed on Aug. 13, 2024.
(60) Provisional application No. 63/682,373, filed on Aug. 13, 2024.
(60) Provisional application No. 63/682,381, filed on Aug. 13, 2024.
(60) Provisional application No. 63/682,373, filed on Aug. 13, 2024.
(60) Provisional application No. 63/821,045, filed on Jun. 10, 2025.

(51) Int. Cl. G06N 3/092

(52) U.S. Cl. CPC G06N 3/092

(57) ABSTRACT

A method, apparatus, and computer-readable medium for optimizing a current value of a content attribute, including determining a value of a content attribute for a content item on nodes of a computer network by applying an attribute determination model to a multidimensional content vector corresponding to the content item, the attribute determination model being configured to determine the value of the content attribute, applying a synchronization function comprising one or more synchronization constraints to update the value of the content attribute, the synchronization function being configured to identify related content items on the computer network and update the value of the content attribute to constrain any deviation between the value of the content attribute for the content item and one or more current values of the content attribute for the one or more related content items to within one or more thresholds defined by the one or more synchronization constraints, and transmit instructions configured to designate the updated value as a current value of the content attribute for the content item on nodes of the computer network.

### RELATED APPLICATION DATA

This application claims priority to U.S. Provisional Application No. 63/821,045, filed Jun. 10, 2025, the disclosure of which is hereby incorporated by reference in its entirety.

This application is a continuation-in-part of U.S. Nonprovisional application Ser. No. 19/299,162, filed Aug. 13, 2025, which itself claims priority to U.S. Provisional Application No. 63/682,381, filed Aug. 13, 2024, and to U.S. Provisional Application No. 63/682,373, filed Aug. 13, 2024, the disclosures of which are hereby incorporated by reference in their entirety.

The application is also a continuation-in-part of U.S. Nonprovisional application Ser. No. 19/299,185, filed Aug. 13, 2025, which itself claims priority to U.S. Provisional Application No. 63/682,381, filed Aug. 13, 2024, and U.S. Provisional Application No. 63/682,373, filed Aug. 13, 2024, the disclosures of which are hereby incorporated by reference in their entirety.

### BACKGROUND

Reinforcement learning (RL) has emerged as a powerful paradigm within the field of artificial intelligence, enabling intelligent agents to learn optimal decision-making strategies through interaction with an environment. Traditional RL methods have demonstrated success in various applications, including game playing, robotics, and autonomous systems. However, challenges persist in terms of balancing the exploration-exploitation trade-off, handling high-dimensional state spaces, and achieving efficient convergence.

Existing RL techniques often face limitations when applied to complex and adaptive environments, hindering their scalability and adaptability. Furthermore, conventional algorithms may struggle with sample inefficiency and require extensive training data to achieve satisfactory performance. Considering these challenges, there is a recognized need for innovations that can enhance the robustness, speed, and applicability of reinforcement learning systems.

### BRIEF DESCRIPTION OF DRAWINGS

FIG. 1 illustrates a flowchart for optimizing a current value of a content attribute according to an exemplary embodiment.

FIG. 2 illustrates an example of an attribute determination model that determines the value of a content attribute according to an exemplary embodiment.

FIG. 3 illustrates an example of multiple attribute determination models corresponding to different publishers according to an exemplary embodiment.

FIG. 4 illustrates a training process for training an attribute determination model according to an exemplary embodiment.

FIG. 5 illustrates the various sources and databases that can be used to construct the multidimensional content vector according to an exemplary embodiment.

FIG. 6 illustrates a multidimensional content vector according to an exemplary embodiment.

FIG. 7 illustrates a flowchart for applying a synchronization function including one or more synchronization constraints to update the value of the content attribute according to an exemplary embodiment.

FIG. 8A illustrates a system diagram showing the process of identifying related content items based on vector similarity measures according to an exemplary embodiment.

FIG. 8B illustrates the process of retrieving current values of the content attribute for the one or more related content items according to an exemplary embodiment.

FIG. 8C illustrates a system chart showing a synchronization engine used to determine whether the deviation between the value of the content attribute for the content item and the one or more current values of the content attribute for the one or more related content items exceeds the one or more thresholds defined by the one or more synchronization constraints according to an exemplary embodiment.

FIG. 8D illustrates an example of the step of updating the value of the content attribute based at least in part on a determination that the deviation between the value of the content attribute for the content item and the one or more current values of the content attribute for the one or more related content items exceeds the one or more thresholds defined by the one or more synchronization constraint according to an exemplary embodiment.

FIG. 9 illustrates a system diagram for transmitting instructions configured to designate the updated value as a current value of the content attribute for the content item on the one or more nodes of the computer network according to an exemplary embodiment.

FIG. 10 illustrates a flowchart for updating a content attribute value based on monitored network activity according to an exemplary embodiment.

FIG. 11 illustrates a flowchart for updating the multidimensional content vector corresponding to the content item based at least in part on the monitored network activity according to an exemplary embodiment.

FIG. 12 illustrates a system chart showing the network monitoring process according to an exemplary embodiment.

FIG. 13 illustrates a system diagram for monitoring network nodes, detecting activity corresponding to content items, and generating an updated multidimensional content vector according to an exemplary embodiment.

FIGS. 14A-14H illustrate additional aspects of the present system, the reinforcement learning agent, and the process of determining the current value of a content attribute according to an exemplary embodiment.

FIG. 15 illustrates the components of a reinforcement learning agent configured to perform the processes described herein.

### DETAILED DESCRIPTION

It is to be understood that at least some of the figures and descriptions of the invention have been simplified to illustrate elements that are relevant for a clear understanding of the invention, while eliminating, for purposes of clarity, other elements that those of ordinary skill in the art will appreciate also comprise a portion of the invention. However, because such elements do not facilitate a better understanding of the invention, a description of such elements is not provided herein.

The present system addresses the above-mentioned challenges by introducing novel methodologies and systems designed to overcome the limitations of traditional RL approaches. Through advancements in algorithmic techniques, continuous learning, self-adjusting, optimizing, model architectures, or system configurations, the present invention results in improved efficiency, adaptability, and real-world applicability.

Unlike traditional AI models that often operate on static model, the proposed invention introduces a paradigm shift by employing Real-Time AI (RTAI). While static models lack the agility to adapt promptly to dynamic environments, the RTAI framework disclosed herein is designed to provide instantaneous responses and adaptability to real-time changes. This innovation is particularly advantageous in scenarios where immediate, context aware decisions are essential, such as dynamic content valuation in digital markets.

In contrast to existing models, such as LLMs, which operate with static databases, the present reinforcement learning system functions in a real-time, dynamic, and complex ecosystem, and can be utilized with a large and fluid dataset. The present system can process interactions involving large numbers of users and changing datapoints, accurately recalibrating values of content attributes in real-time. This enables the model of the present system to be utilized across various sectors and solutions, particularly in addressing complex, dynamic, and real-time adaptive scenarios. The deep reinforcement learning system of the present application can rapidly adapt in real-time to changing environments, both in terms of adapting policies and making decisions in real-time.

The disclosed adaptive reinforcement earning system can be accessed by one or more users by means or a web or mobile application running on one or more computing devices or the one or more users over a communication network. The disclosed adaptive reinforcement learning system can be utilized by the one or more users to perform one or more keyword-based searches for retrieving one or more digital content items from the World Wide Web or one or more databases in real time.

The system can be configured to determine a set of parameters based on searching activities of a user in the plurality of categories, where the set of parameters are the content attributes of one or more content items, learn the set of parameters to maximize the value function, synchronize, one or more specific action outputs using one or more synchronization constraints, maintain coherence among similar entities, where the coherence is maintained by comparing a first content genome of a first digital content to a second content genome of a second digital content, optimize a utility function for one or more individual entities, and self-adjust, the reinforcement learning algorithm. The term content genome, as used herein, refers to a multidimensional content vector corresponding to a content item. The multidimensional content vector stores a plurality of content feature/attribute values relating to a content item, as is discussed in greater detail below.

The present system expands the reinforcement learning framework by introducing synchronization constraints, penalizing significant differences between values of entities that exhibit high similarity. It aims to maintain coherence among similar entities while optimizing a utility function for individual entities. By applying this strategy, the methodology uniquely combines traditional reward optimization with synchronization constraints, fostering more aligned policies or values among similar entities.

The present system can be utilized in a variety of domains, such as content networks and content distribution networks, healthcare, finance, manufacturing, education, entertainment. Specifically, the disclosed methodologies, algorithms, and systems designed for leveraging Al models can be used in healthcare settings for disease diagnosis, treatment optimization, and patient care. Furthermore, within the financial sector, the present system can be used for fraud detection, risk assessment, algorithmic trading, trading, and customer service automation using Al models. In the realm of manufacturing, the present system can be used for predictive maintenance, quality control, supply chain optimization, and autonomous robotics. Moreover, in education, the present system facilitates adaptive learning platforms, personalized tutoring, grading automation, and educational content generation through Al models. Additionally, within the entertainment industry, the system introduces advancements in content recommendation systems, gaming AI, music composition, and video editing leveraging the capabilities of Al models. The system encompasses distinctive and innovative methodologies tailored to each domain, providing improved efficiency, accuracy, and advancements in diverse application areas utilizing Al models.

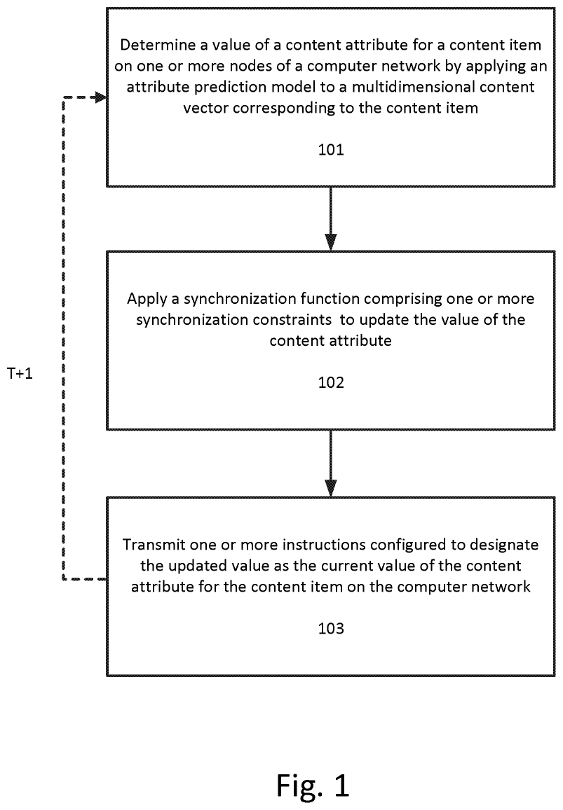

FIG. 1 illustrates a flowchart for optimizing a current value of a content attribute according to an exemplary embodiment. The steps shown in FIG. 1 can be performed by one or more computing devices of a reinforcement learning agent.

At step 101 a value of a content attribute for a content item on a computer network is determined by applying an attribute determination model to a multidimensional content vector corresponding to the content item, the attribute determination model being configured to determine the value of the content attribute.

The content attribute can be, for example, the price or quantitative market value (QMV) of the content item or the value of the digital content, such as articles, news, analysis, images, video, audiovisual content, or any other digital content. As used herein, the QMV refers to a quantitative market price determined by the system. The price of a particular item of content may or may not correspond to the QMV. For example the price of an item of content may be much higher or lower than the QMV for the content, due to publisher preferences/settings. Other content attributes can include, for example, reliability, popularity, accuracy, age, etc. In content distribution systems that store a real-time QMV for different items of content, QMV changes to one item of content can be propagated to related or similar items of content to trigger QMV changes in the similar content items.

The content item can be any type of content, including text, articles, news stories, documents, audio content, visual content, audiovisual content, streaming content, audio clips, songs, videos, images, podcasts, multimedia content, electronic books, audio books, or any other content.

The one or more network nodes are network locations where the content item is published, stored, and/or hosted. The network nodes can be web servers, file servers, application servers, file transfer protocol (FTP) servers, mail servers, database servers, media servers, e-commerce servers, directory servers, content hosting websites, content publisher websites, and/or content provider websites. For example, the network nodes can be news media websites or news aggregators. In another example, the network nodes can also be video sharing or social media sites.

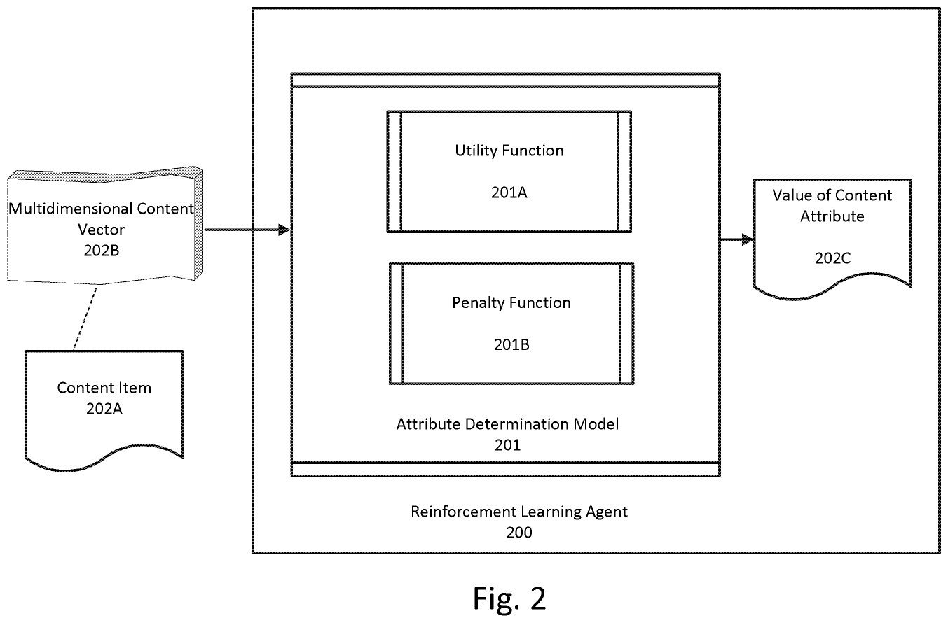

FIG. 2 illustrates an example of an attribute determination model that determines the value of a content attribute according to an exemplary embodiment. As shown in FIG. 2, a multidimensional content vector 202B corresponding to content item 202A is provided to an attribute determination model 201 within reinforcement learning agent.

The attribute determination model 201 is applied to the multidimensional content vector 202B to determine a value of a content attribute 202C for the content item 202A. The content attribute can be, for example, a price or quantitative market value (QMV) of the content item (such as a current price on a network node that hosts the content item).

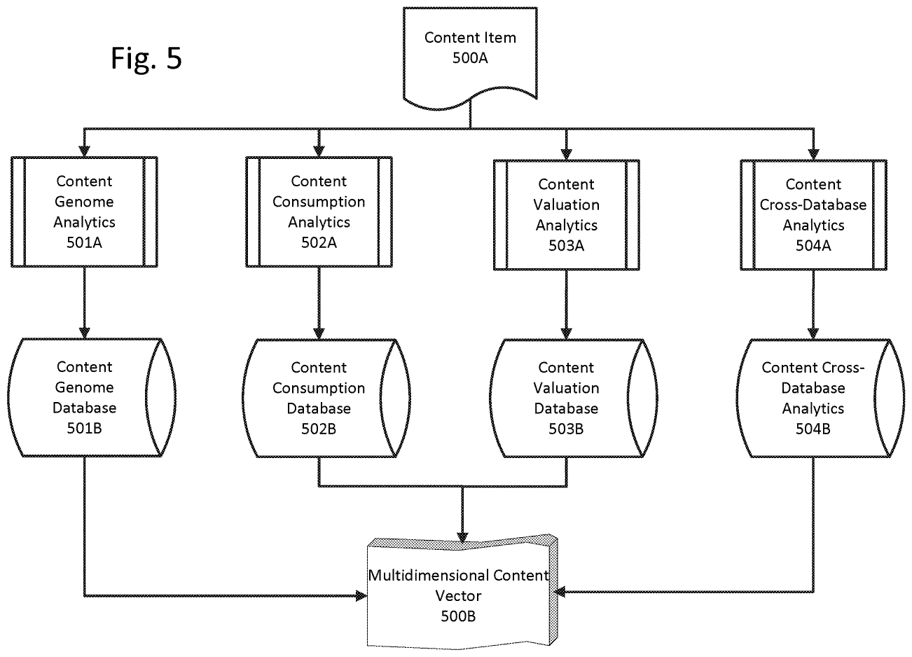

The multidimensional content vector 202B is described in greater detail with respect to FIG. 5 and can have any number of dimensions, such as dozens or hundreds of dimensions. For example, the multidimensional content vector can have 756 dimensions. Each dimension in the multidimensional content vector corresponds to a different content attribute relating to the content item. The content attributes relating to the content item can include attributes such as semantic features, syntactic features, metadata, etc. The content attributes relating to the content item can also be attributes relating to content consumption, content metrics, or other attributes related to the content.

The multidimensional content vector 202B can be generated by one or more encoders that can be part of the reinforcement learning agent 200 or some other part of the system (such as a content ingestion engine). The encoders can aggregate the relevant content attributes for each content item and then encode the content attributes to generate the multidimensional content vector 202B corresponding to the content item.

As shown in FIG. 2, the attribute determination model 201 includes a utility function 201A and a penalty function 201B. The attribute determination model is configured to maximize the utility function and minimize the penalty function. The utility function is derived based at least in part on the content attribute and the penalty function penalizes differences between the determined content attribute value and a reward function content attribute value determined based on a reward function

The utility function can be derived based at least in part on the content attribute and the utility function can be domain dependent. For example, in a dynamic pricing domain, the utility function can be a reward function which dynamically adapts the pricing to maximize the revenue. In this example, if the content attribute is the content price, the utility function can be a function that determines a content price that is configured to maximize a potential revenue of the publisher of the content. The objective of the reinforcement learning agent can be to optimize a function that balances values across various content items while maximizing the utility function U(xᵢ) associated with the content items.

The attribute determination model can apply a utility function and a penalty function as set forth in the equation below:

$$max ( {\sum }_{i = 1}^{K} U ( {x}_{i} ) - α {\sum }_{j} {w}_{ij} \cdot {( {x}_{i} - {x}_{j} )}^{2} )$$

U(xᵢ) denotes a utility function associated with the value of entity i, which needs to be maximized. The utility function can be configured to maximize different values, depending on the requirements of a particular publisher, content producer, and/or content host. For example, the utility function can be configured to maximize the revenue derived from content. In the scenario where the content attribute being determined is price, the attribute determination model determines a content price for content that the attribute determination model indicates would maximize the revenue derived from that content.

The second term, reproduced below, represents a penalty function that penalizes the square difference between values of similar entities (i and j) when the similarity between them exceeds a given threshold.

αΣⱼwᵢⱼ·(xᵢ−xⱼ)²

The utility function and penalty function are configured to maximize the utility derived from values while penalizing significant differences between similar entities, ensuring that entities with high similarity have values that align more closely.

The generalized equation above aims to maximize the utility derived from entity values while penalizing significant differences between similar entities, ensuring that entities with high similarity have values that align more closely.

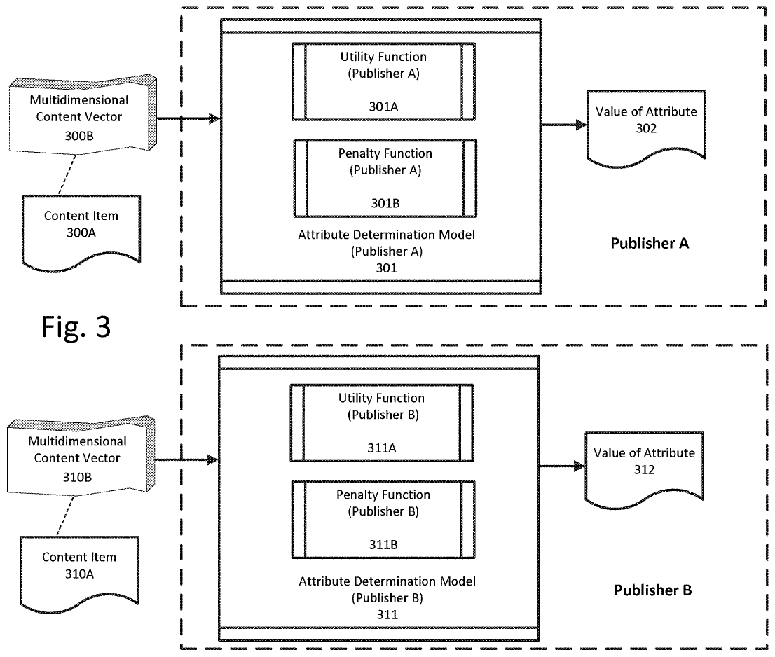

Multiple attribute determination models can be utilized corresponding to different content publishers or content hosts. FIG. 3 illustrates an example of multiple attribute determination models corresponding to different publishers according to an exemplary embodiment.

As shown in FIG. 3, attribute determination model 301 is utilized by Publisher A and attribute determination model 311 is utilized by Publisher B. Attribute determination model 301 includes utility function 301A and penalty function 301B and attribute determination model 311 includes utility function 311A and penalty function 311B. Attribute determination model 301 is applied to multidimensional vector 300B corresponding to content item 300A to determine value of content attribute 302 corresponding to content 300A. Similarly, attribute determination model 311 is applied to multidimensional vector 310B corresponding to content item 310A to determine value of content attribute 312 corresponding to content 310A.

The utility function 301A and penalty function 301B utilized in the attribute determination model 301 used for Publisher A can differ from the utility function 311A and penalty function 311B utilized in the attribute determination model 311 used for Publisher B. For example, Publisher A and Publisher B can have different goals in terms of maximizing revenue or optimizing some other content-related metric. Additionally, Publisher A and Publisher B can both have a goal of maximizing revenue, but the utility functions and penalty functions can vary based on differences in the attributes of the content published or hosted by Publisher A and Publisher B, the goals or targets of Publisher A and Publisher B, or other factors. The differences in the attribute determination models utilized by Publisher A and Publisher B can be the result of the model training process, as described below.

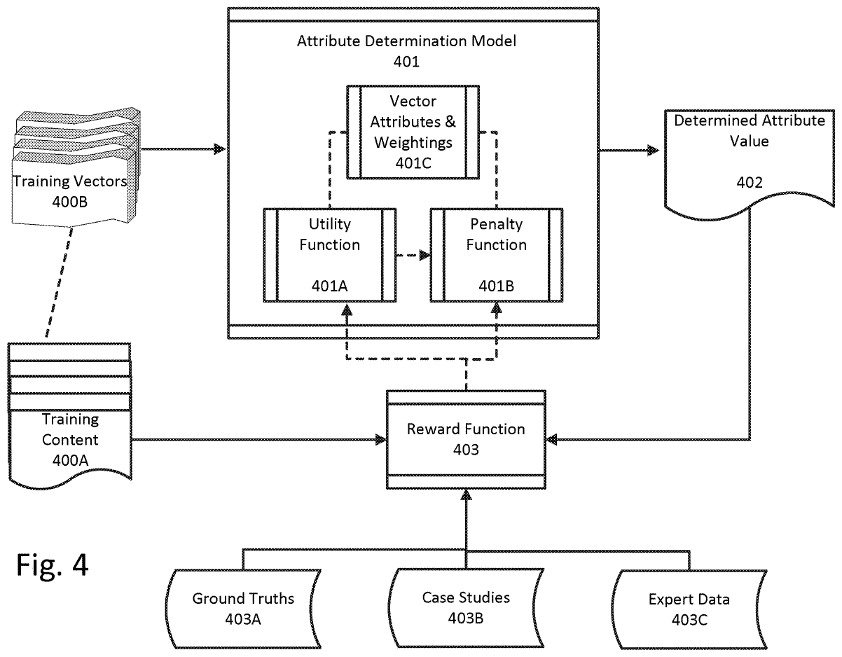

FIG. 4 illustrates a training process for training an attribute determination model according to an exemplary embodiment. During training, training vectors 400B corresponding to training content 400A are provided to the attribute determination model 401. The attribute determination model 401 determines an attribute value 402 corresponding to the training content 400A.

The training content 400A is provided to a reward function 403, along with ground truths 403A, case studies 403B, and expert data 403C. The reward function 403 is configured to assess the determined attribute value 402 for each item of training content 400A in conjunction with the ground truths 403A, case studies 403B, expert data 403C and to adjust the utility function 401A and/or the penalty function 401B of the attribute determination model 401. These adjustments to the utility function 401A and the penalty function 401B result in changes to the vector attributes and the vector attribute weightings 401C that are used by the attribute determination model 401 to determine an attribute value.

In the process of training and applying the reward function 403, the attribute determination model 401 learns which parameters/attributes are relevant for determining an attribute value that maximizes the utility function 401A while minimizing the penalty function 401B. The attribute determination model 401 also learns the proper weightings, in terms of importance, for the relevant parameters/attributes that result in the model determining an attribute value that maximizes the utility function while minimizing the penalty function.

The particular parameters/attributes and weightings 401C within the content vectors used by the attribute determination model 401 to determine an attribute value 402 corresponding to the content can vary depending on the type of content, content attributes of the content, attributes relating to publication, distribution, or consumption of the content, and/or attributes relating to the publisher or content host, just as the metrics maximized by the utility function and/or minimized by the penalty function. For example, an attribute determination model configured to maximize revenue for a publisher of sports content can identify the parameters of content publication date and content category as the most important parameters/attributes of the content to set the price of the content. Alternatively, an attribute determination model configured to maximize revenue for a publisher of cooking content can identify the parameters of content length and content traffic as the most important parameters/attributes of the content to set the price of the content. The variations in the attribute determination model are developed during the training stage and are reflected in the vector attributes and vector weightings used by the attribute determination models.

As discussed above, the attribute determination model is applied to a multidimensional content vector corresponding to content. The multidimensional content vector can include a plurality of feature values corresponding to a plurality of features relating to the content item. The plurality of features can include one or more of the content publisher, content provider, content language, content format, content category, content quality, content originality, content bias, content topic engagement, content rating, content seasonality, content value analysis, content user engagement, content domain performance, content user journey analysis, content time spent, content valuation trends, content initial price, content price forecast, content engagement correlation, content return on investment, content performance by language and domain, and/or content user engagement and valuation forecast.

FIG. 5 illustrates the various sources and databases that can be used to construct the multidimensional content vector according to an exemplary embodiment. The content item 500A can be input to various different processes, including content genome analytics process 501A, content consumption analytics process 502A, content valuation analytics process 503A, and/or content cross-database analytics process 504A.

Content genome analytics process 501A can be performed by content analysis software including various feature extraction models. As used herein, the term “feature” refers to content attributes/parameters of the content items, such as content type, content subject, content length, etc. The feature extraction models can be customized to different types of content. The feature extraction models corresponding to each different type of content can be trained specifically for that type of content. For example, a first set of feature extraction models can be trained to extract features from textual content, a second set of feature extraction models can be trained to extract features from audio content, a third set of feature extraction models can be trained to extract features from image content, and a fourth set of feature extraction models can be trained to extract features from video content. The type of content can be determined based on the multidimensional content vector generated previously, and this determination can then be used to select and apply the appropriate set of feature extraction models. For example, the content type can be determined by applying a Boolean operation to multidimensional content vector to assess if the multidimensional content vector conforms to the requirements for a particular type of content. Features/parameters that are extracted by the content genome analytics process 501A can be stored in the content genome database 501B.

Content consumption analytics process 502A analyzes consumption data pertaining to the content on the network, such as views, downloads, purchases, network traffic, comments, etc. Content consumption analytics can be gathered by one or more network monitoring agents on content network. Network monitoring agents can monitor nodes/websites/content hosting locations for different publishers and compile content consumption analytics. The content consumption features pertaining to the content can then be stored in the content consumption database 502B.

Content valuation analytics process 503A can determine valuation features pertaining to the content. Valuation features can include, for example, a valuation or QMV forecast, valuation trends, and other valuation related features. The content valuation features can be stored in the content valuation database 503B.

Content cross-database analytics process 504A can determine features involving relationships between different types of content feature databases. This can include, for example, combined data features from the content genome and valuation databases. The content cross-database analytics features can be stored in the content cross-database analytics database 504B.

Various features stored in the content genome database 501B, the content consumption database 502B, the content valuation database 503B, and the content-cross-database analytics database 504B can then be combined to generate a multidimensional content vector 500B corresponding to content item 500A. The table below lists exemplary features/attributes that can form part of the multidimensional content vector 500B, as well as the source database for each of the attributes/features and descriptions of the features/attributes.

| No. | Feature/Attribute | Database | Analytics Insights |
|---|---|---|---|
| 1 | Content Quality Analysis | Content Genome Database | Track distribution of |
| | | | content quality scores |
| | | | over time in comparison |
| | | | to market trends |
| 2 | Topic Engagement | Content Genome Database | Analyze popularity of |
| | | | different content topics |
| 3 | Rating Trends | Content Genome Database | Monitor distribution of |
| | | | user ratings for content in |
| | | | comparison to market |
| | | | trends |
| 4 | Content Language | Content Genome Database | Understand language |
| | Preferences | | distribution of content |
| 5 | Content Seasonality | Analytics | Explore content |
| | | | engagement variations |
| | | | with seasons |
| 6 | Average QMV Analysis | Content Genome Database | Track average Quality |
| | (Content Value Analysis) | | against Average Market |
| | | | value across contents per |
| | | | domain of content |
| 7 | User Engagement | Analytics | Track user engagement |
| | Analysis | | metrics (session duration, |
| | | | interaction frequency) |
| 8 | Content Domain | Analytics | Analyze user |
| | Performance | | interactions based on the |
| | | | domain of content |
| 9 | User Journey Analysis | Analytics | Create user journey |
| | | | visualizations to |
| | | | understand how users |
| | | | navigate through the |
| | | | contents |
| 10 | Time Spent on Content | Analytics | Analyze average time |
| | | | users spend on different |
| | | | types of contents |
| 11 | Valuation Trends | Valuation | Track changes in content |
| | | | valuation over time |
| 12 | Comparison with Initial | Valuation | Compare initial content |
| | Price | | price with its valuation |
| 13 | Valuation Forecast | Valuation | Utilize historical data to |
| | | | forecast valuation for the |
| | | | next 72 hours |
| 14 | Correlation with User | Valuation | Explore correlation |
| | Engagement | | between content valuation |
| | | | and user engagement |
| | | | metrics |
| 15 | Content ROI Analysis | Cross-Database Insights | Combine data from |
| | | | Content Genome and |
| | | | Valuation databases |
| 16 | Content Performance by | Cross-Database Insights | Analyze user |
| | language and domain | | interactions based on both |
| | | | language and domain |
| 17 | User Engagement and | Cross-Database Insights | Explore future valuation |
| | Valuation forecast | | based on user engagement |

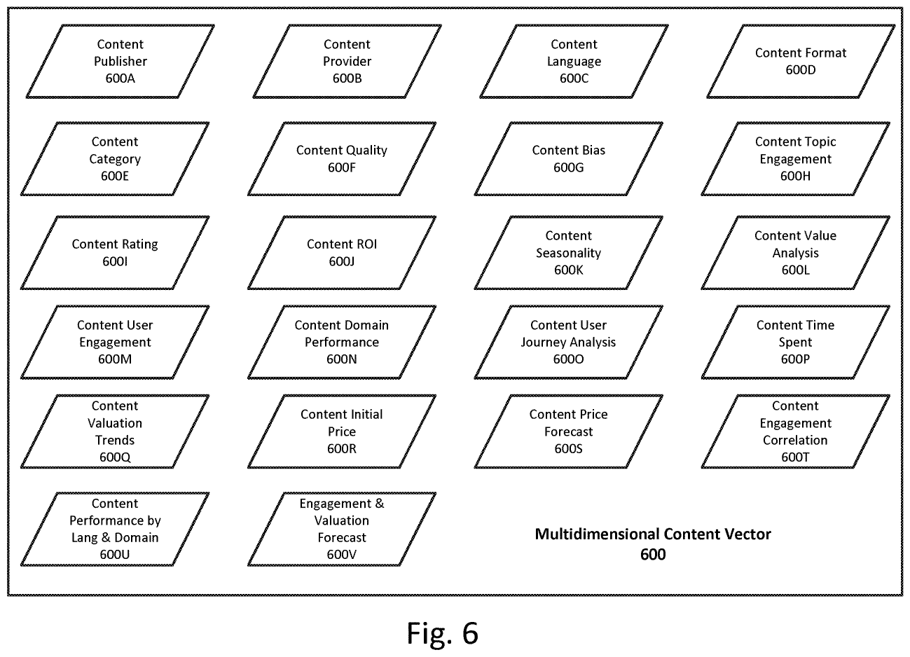

FIG. 6 illustrates a multidimensional content vector according to an exemplary embodiment. As shown in FIG. 6, the multidimensional content vector 600 can include several features/attributes, with each feature/attribute corresponding to a different dimension in the multidimensional content vector 600. In the example of FIG. 6, multidimensional content vector 600 includes the feature values for content publisher 600A, content provider 600B, content language 600C, content format 600D, content category 600E, content quality 600F, content bias 600G, content topic engagement 600H, content rating 600I, content return on investment 600J, content seasonality 600K, content value analysis 600L, content user engagement 600M, content domain performance 600N, content user journey analysis 6000, content time spent 600P, content valuation trends 600Q, content initial price 600R, content price forecast 600S, content engagement correlation 600T, content performance by language and domain 600U, and content user engagement and valuation forecast 600V.

The above-mentioned features are explained in greater detail in the table above. In addition to the features listed in the table, the multidimensional content vector 600 includes a content publisher 600A, a content provider 600B, content language 600C, content format 600D, content category 600E, and content bias 600G. The content publisher 600A corresponds to the entity that has published the content, such as a particular news source, magazine, etc.

The content provider 600B is the provider of the content, and can be the same as the publisher or can be a downstream party, such as a content distributor or some other source for the content apart from the publisher.

The content language 600C indicates the language of the content, such as English, Spanish, French, Chinese, etc.

The content format 600D indicates the content format of the content, such as video, audio, text, etc. The content category 600E indicates one or more categories associated with the content, such as news, sports, current events, cooking, politics, etc.

Additionally, the content bias 600G indicates a bias associated with the content. The content bias can be determined with a classifier or other model that is trained to estimate or identify a potential bias associated with the content.

Classifiers can be trained and used to identify/determine several of the attributes/features represented in the multidimensional content vector 600, such as content language 600C, content category 600E, content quality 600F, content bias 600G, or any other attributes/features.

Returning to FIG. 1, at step 102 a synchronization function comprising one or more synchronization constraints is applied to update the value of the content attribute. The synchronization function is configured to identify one or more related content items on the computer network and update the value of the content attribute to constrain any deviation between the value of the content attribute for the content item and one or more current values of the content attribute for the one or more related content items to within one or more thresholds defined by the one or more synchronization constraints.

The purpose of the synchronization function and synchronization constraints is to align the determined content attribute value with content attribute values of related content items, including similar content items and/or identical content items on the same or different publishers. The synchronization function is configured to identify one or more related content items on the computer network based at least in part on one or more vector similarity measures between the multidimensional content vector corresponding to the content item and one or more multidimensional content vectors corresponding to the one or more related content items.

In the scenario where the content attribute is price or quantitative market value (QMV), a QMV can be determined for an item of content in step 101. At step 102, the current QMV for related items on the content network can be determined, including content items on different publishers or different network nodes. Based on the synchronization constraints and the values of the QMVs for the related content, the QMV for the item of content can be updated to ensure that the QMV for the content item does not deviate beyond a predetermined threshold from the QMVs for the related content (including similar and/or identical content). Therefore, the synchronization function and synchronization constraints act as guardrails to ensure that the determined QMV does not greatly deviate from the QMVs for related content.

The reinforcement learning framework utilized by the present system is also referred to herein as Complex Adaptive Reinforcement Learning (CARL). Some of the distinctive features that contribute to the efficacy and performance of the present system are summarized in the table below, assuming a content attribute of price or quantitative market value (QMV).

| # | Parameters | Description |
|---|---|---|
| 1 | Adaptive ( ) | The actual price of the digital content. This is the |
| | | initial value at which the content is offered to |
| | | consumers. This is calculated using a Model using |
| | | content attributes along with User Interactions. |
| 2 | Content attributes | Extracted from content genome. Less dynamic |
| | | features of contents. Content type, Size, Factual |
| | | correctness, Sentiment around, Day of Publish, |
| | | Relevance, Quality etc. |
| 3 | User Interactions | Details about user interactions regards to content. |
| 4 | Price window | Lower and Upper limit of the content price/QMV as |
| | | that can be set by CARL |
| 5 | Global average mean | Average of QMVs on similar/related content items. |

When the relevant content attribute that is being determined by the attribute determination model is quantitative market value and when the utility function is configured to maximize revenue generated by the content, there are a number of key business relevant attributes/parameters central to the application of reinforcement learning within the disclosed system. These parameters are summarized in the table below:

| # | Parameters | Description |
|---|---|---|
| 1 | QMV (Adaptive) | The price of the content determined by |
| | | CARL from pervious triggers/frequency |
| 2 | User Purchase signals | Details about user purchase data on the |
| | | content |
| 3 | Time of Day & Location | Time of Day refers to the time when the |
| | | pricing decision is made. It can consider |
| | | factors such as morning, afternoon, |
| | | evening, or specific times of the day. |
| | | This will also account for any social |
| | | economic macro/micro events |
| | | happening. |
| 4 | Price Elasticity | Price Elasticity is a measure of how |
| | | sensitive demand is to changes in price. It |
| | | quantifies the responsiveness of |
| | | consumer demand to changes in the price |
| | | of a content. A higher magnitude of |
| | | elasticity indicates that demand is more |
| | | sensitive to price changes. |
| 5 | Revenue | Revenue is the total income generated |
| | | from pricing decisions. It accounts for the |
| | | sum of money earned through the sale of |
| | | digital content at a given price. |
| 6 | Publisher/Client specific | Any subscription plan/coupon code |
| | | presence/Discount %/Loyalty |
| | | programs/Any other agreements |
| 7 | Desired profit margin | Desired Profit Margin (PM) indicates the |
| | | target profit margin that pricing decisions |
| | | aim to achieve. It helps in setting pricing |
| | | strategies that align with profit goals. |
| 8 | Price Lock/Hedging strategy | To preserve the price for specific time |
| 9 | IP Rights/Inventory Limits | Represent constraints on the number of |
| | | copies on downloads available for digital |
| | | content (if they come under any IP) |
| 10 | Distribution Channel Strategies | Considers how the contents are delivered |
| | | (via Mobile Systems/Any other channels) |
| 11 | Loss Recovery % | The percentage of the initial discount that |
| | | customers can recover. |
| 12 | Psychological & Decoy Strategies | Introduce a third, less attractive option (a |
| | | decoy) to influence the perceived value |
| | | of the other two options. Customers may |
| | | opt for the middle option, feeling like |
| | | they're avoiding a loss. |

Additionally, in the price and QMV context, the reinforcement learning agent of the present system can generate a number of outputs as part of the attribute determination and/or synchronization process that enable the system to determine whether to update/adjust a determined QMV/price, how to update/adjust a determined QMV/price, bounds and windows for adjustment of the determined QMV/price, and/or other outputs that influence how the system updates the determined price/QMV. These outputs are summarized in the table below:

| # | Output | Description |
|---|---|---|
| 1. | Pay window | Assess the situation and generates the outcome to |
| | | decide whether to classify a content as pay window |
| | | candidate or not. A pay window candidate can have |
| | | price adjusted within a window of the current price. |
| 2. | Boost Factor | Arrives at a factor (Positive for price increase/ |
| | | Negative for decrease). This indicates whether to |
| | | increase or decrease price. |
| 3. | Synchronization penalty | For similar content items that have prices outside a |
| | | certain threshold difference to the price of the current |
| | | content item. |

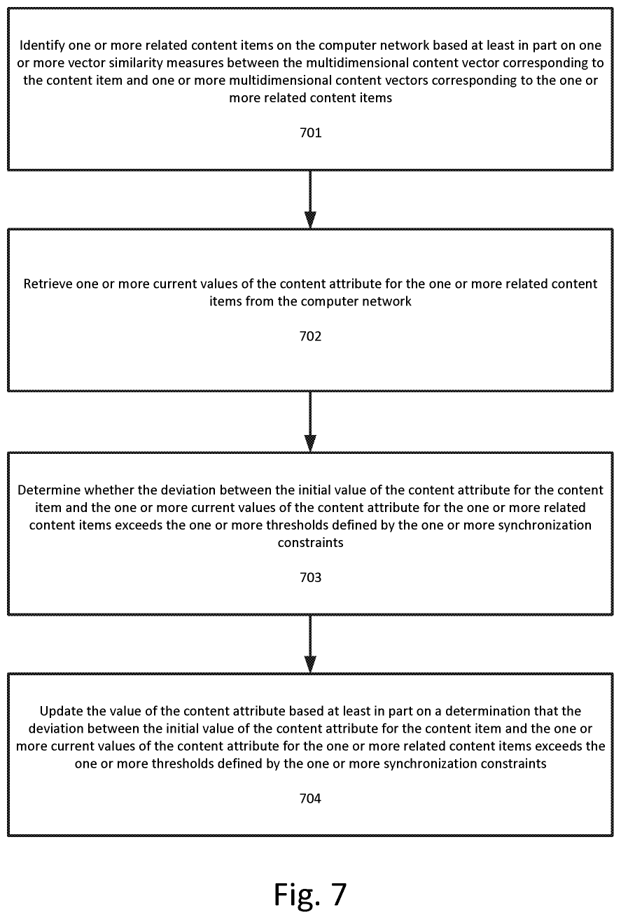

FIG. 7 illustrates a flowchart for applying a synchronization function including one or more synchronization constraints to update the value of the content attribute according to an exemplary embodiment.

At step 701 one or more related content items on the computer network are identified based at least in part on one or more vector similarity measures between the multidimensional content vector corresponding to the content item and one or more multidimensional content vectors corresponding to the one or more related content items.

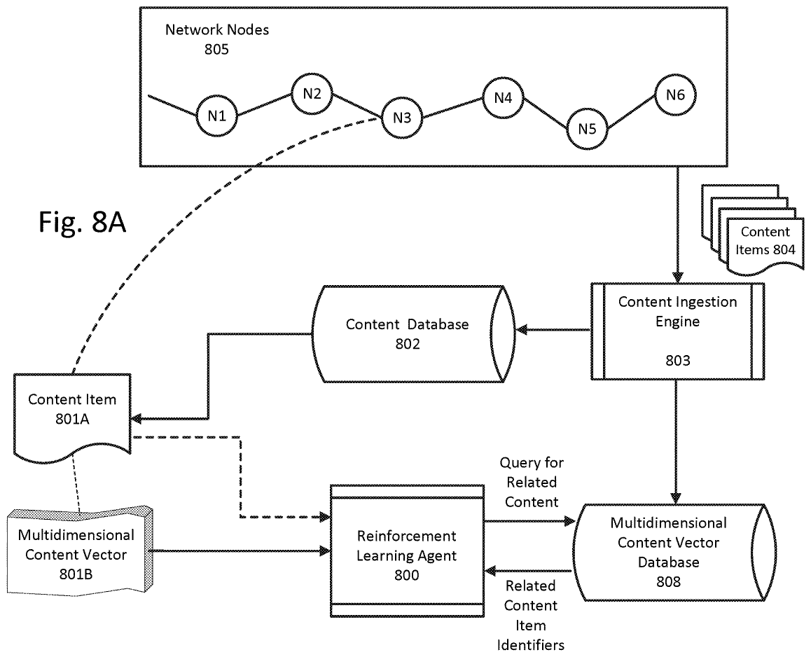

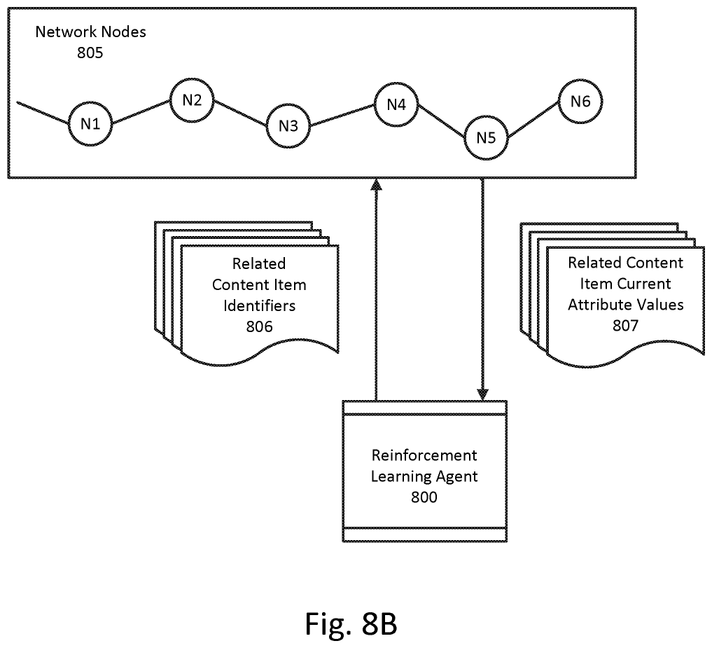

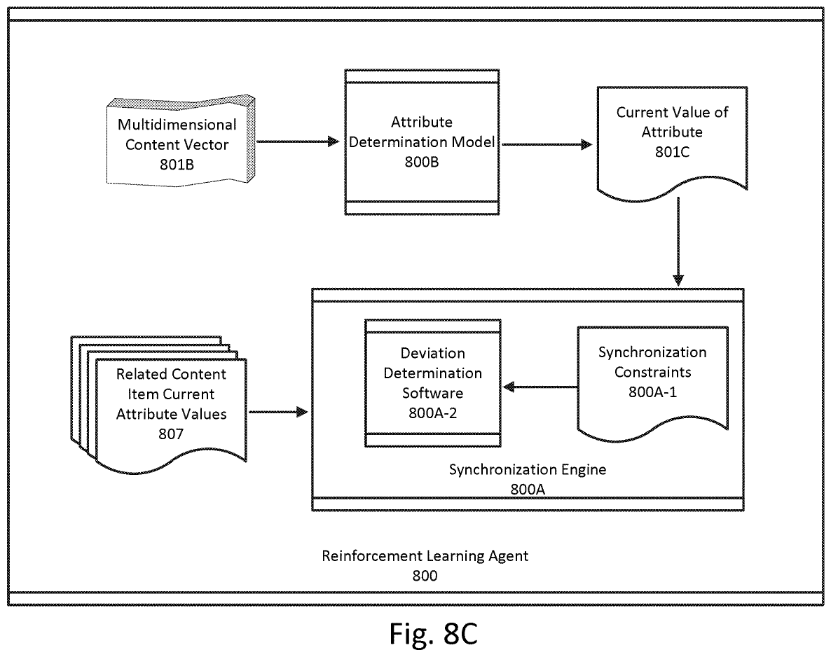

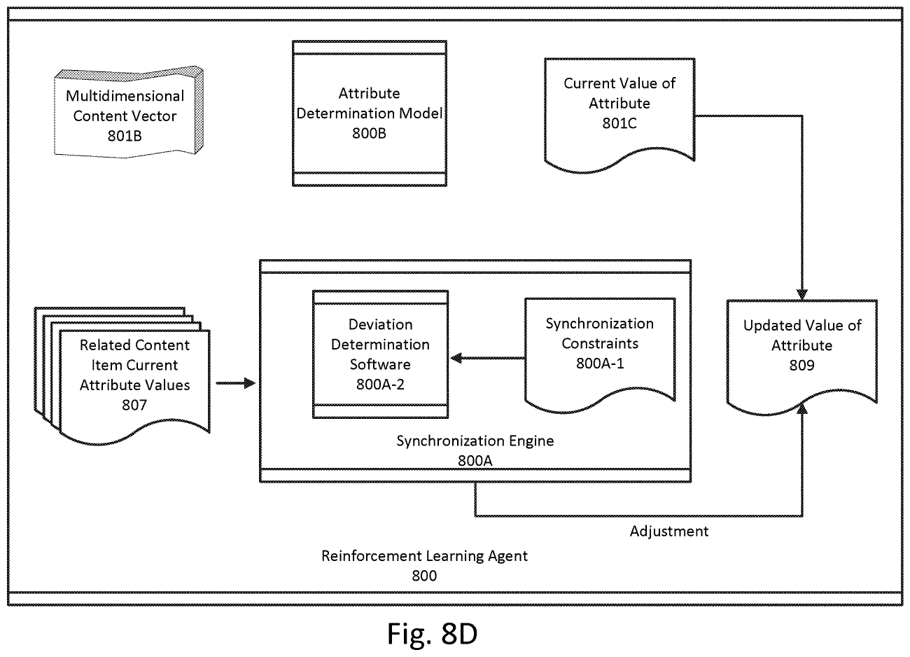

FIG. 8A illustrates a system diagram showing the process of identifying related content items based on vector similarity measures according to an exemplary embodiment. Content items 804 are collected from various network nodes 805 by the content ingestion engine 803. The content items 804 can then be stored in content database 802 and multidimensional content vectors corresponding to the content items 804 can be stored in multidimensional content vector database 808.

In the example of FIG. 8A, the content item that is being processed (to determine the content attribute value) is content item 801A, which can be retrieved from the content database 802. A multidimensional content vector 801B corresponding to content item 801A can be generated (e.g., by an encoder) and provided to the reinforcement learning agent 800. Alternatively, the content item 801A itself can be provided to reinforcement learning agent 800 and the reinforcement learning agent can generate the multidimensional content vector 801B via an internal encoder.

The reinforcement learning agent 800 can query the multidimensional content vector database 808 for content that is related to content item 801A, such as similar content or identical content. The multidimensional content vector database 808 stores the content ingested from network nodes 805 and can include an indication of the source of the content and network nodes. The query can include the multidimensional content vector 801B, the content item 801A, and/or other data extracted from or derived from the content item.

In response to the query, identifiers corresponding to related content items can be retrieved from the multidimensional content vector database 808. The related content items can be identified in a variety of ways, such as with vector similarity measures that compare the multidimensional content vector 801B with vectors stored in the multidimensional content vector database 808 to identify vectors that are within a predetermined distance in the vector space or otherwise similar to the multidimensional content vector 801B. This functionality can be performed by the reinforcement learning agent 800, an agent executing on the multidimensional content vector database, and/or some other software component. Regardless of how the related content items are identified, the related content item identifiers are provided to the reinforcement learning agent 800.

Returning to FIG. 7, at step 702 one or more current values of the content attribute for the one or more related content items are retrieved from the computer network. FIG. 8B illustrates the process of retrieving current values of the content attribute for the one or more related content items according to an exemplary embodiment.

The reinforcement learning agent 800 can use the related content item identifiers 806 to retrieve related content item current attribute values 807. In the scenario where the content attribute is quantitative market value, the reinforcement learning agent 800 can retrieve the quantitative market values of the related content items. For example, if the content item is an article on a particular publisher site, the quantitative market values of the article on other sites or of similar articles can be retrieved.

Although FIG. 8B illustrates the reinforcement learning agent 800 as communicating directly with the network nodes 805, it is understood that one or more additional components can be disposed between reinforcement learning agent 800 and the network nodes 805 to facilitate retrieval of related content item current attribute values 807. For example, a network directory, index, or other lookup structure can be used to determine where on the network (e.g., which network nodes 805) host particular content items, such as each of the related content items. The relevant network nodes can then be queried for current attribute values. Alternatively, the network directory, index, or other lookup structure can be incorporated into reinforcement learning agent 800.

FIG. 8B illustrates the related content item current attribute values 807 being retrieved directly from the network nodes 805, but it is understood that the related content item current attribute values 807 can be retrieved from a database or data store that tracks various parameters for different content items. For example, a content database (such as the content database shown in FIG. 8A) can store information about each content item and various attributes, such as the current quantitative market value, network traffic information, and other information. The database can be connected to the network nodes 805 and can be configured to monitor the network nodes and/or to periodically retrieve data from the network and update content attributes, such as quantitative marker value. In this case, the reinforcement learning agent 800 can communicate directly with the relevant database and use the related content item identifiers 806 to retrieve the related content item current attribute values 807.

Returning to FIG. 7, at step 703 it is determined whether the deviation between the value of the content attribute for the content item and the one or more current values of the content attribute for the one or more related content items exceeds the one or more thresholds defined by the one or more synchronization constraints.

FIG. 8C illustrates a system chart showing a synchronization engine used to determine whether the deviation between the value of the content attribute for the content item and the one or more current values of the content attribute for the one or more related content items exceeds the one or more thresholds defined by the one or more synchronization constraints according to an exemplary embodiment.

As discussed previously, the synchronization process acts as a guardrail to ensure that the determined current value of the attribute does not deviate greatly (e.g., beyond a predetermined threshold) from attribute values for related content items, such as similar content items or identical content items.

Referring to FIG. 8C, the attribute determination model 800B on the reinforcement learning agent 800 is applied to the multidimensional content vector 801B corresponding to the relevant content item to determine a current value of the attribute 801C, as discussed previously. The current value of the attribute 801C is provided to synchronization engine 800A, along with the related content item current attributes 807, discussed with respect to FIG. 8B.

The synchronization engine 800A includes deviation determination software 800A-2. The deviation determination software 800A-2 takes as input synchronization constraints 800A-1, the current value of attribute 801C, and related content item current attribute values 807 and determines whether the deviation between the value of the content attribute for the content item 801C and the one or more current values of the content attribute for the one or more related content items 807 exceeds the one or more thresholds defined by the one or more synchronization constraints 800A-1.

Of course, the synchronization constraints 800A-1 and the particular methodologies or thresholds used by the deviation determination software 800A-2 can vary depending on the particular content attribute being assessed by the synchronization engine.

Returning to FIG. 7, at step 704 the value of the content attribute is updated based at least in part on a determination that the deviation between the value of the content attribute for the content item and the one or more current values of the content attribute for the one or more related content items exceeds the one or more thresholds defined by the one or more synchronization constraints.

The value of the content attribute can be updated in various ways and according to various methodologies. For example, updating the value of the content attribute can include modifying the value of the content attribute to fall within a threshold range of an average value of the content attribute for the one or more related content items. When the content attribute is quantitative market value or price, this step can include determining an average price for the content across the network and updating the determined price for the content item to be within a predetermined proximity/threshold to the average price. Alternatively, if the value of the content attribute is already within the predetermined threshold, then the value (such as the price/QMV) does not need to be updated.

FIG. 8D illustrates an example of the step of updating the value of the content attribute based at least in part on a determination that the deviation between the value of the content attribute for the content item and the one or more current values of the content attribute for the one or more related content items exceeds the one or more thresholds defined by the one or more synchronization constraint according to an exemplary embodiment.

As discussed previously, the deviation determination software 800A-2 takes in synchronization constraints 800A-1, current value of attribute 801C, and related content item current attribute values 807 and determines whether the deviation between the current value of attribute 801C relative to the related content item current attribute values 807 exceeds a predetermined threshold defined by the synchronization constraints 800A-1.

When the deviation does not exceed the predetermined threshold, then the current value of the attribute does not require updating. However, when the deviation does exceed the predetermined threshold, then the synchronization engine 800A can apply an adjustment to the current value of the attribute 801C to produce the updated value of the attribute 809, as shown in FIG. 8D.

Returning to FIG. 1, at step 103 one or more instructions are transmitted that are configured to designate the updated value as a current value of the content attribute for the content item on the one or more nodes of the computer network.

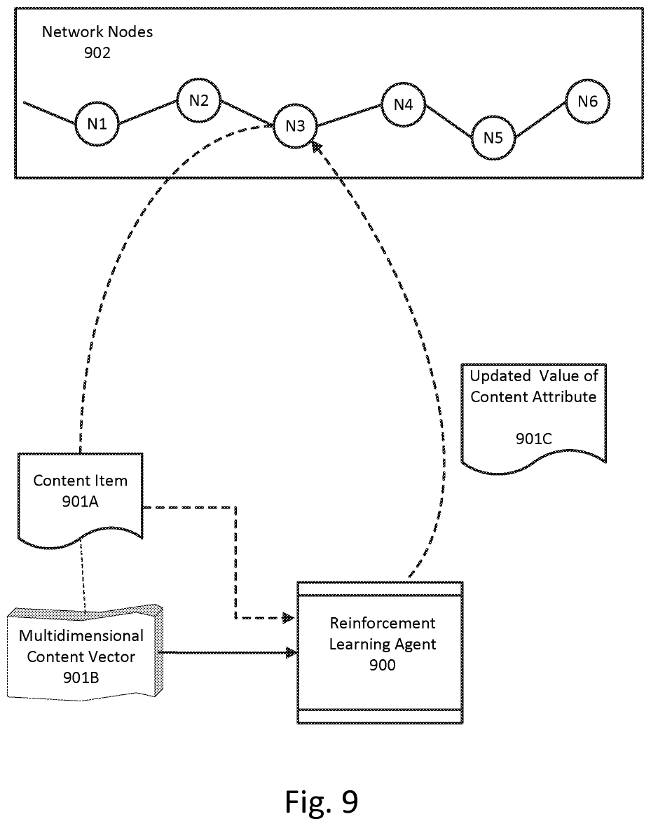

FIG. 9 illustrates a system diagram for transmitting instructions configured to designate the updated value as a current value of the content attribute for the content item on the one or more nodes of the computer network according to an exemplary embodiment.

As shown in FIG. 9, the reinforcement learning agent takes as input content item 901A and/or multidimensional content vector 901B and determines an updated value of a content attribute 901C, such as a updated quantitative market value or price. The process for determining an updated value of the content attribute is discussed in detail above.

The content item 901A can correspond to node N3 in the network nodes 902. For example, node N3 can be a news website hosting the content item 901A. After the reinforcement learning agent 900 determines and updated value of the content attribute 901C, the updated content attribute value can be transmitted to the relevant network node (e.g., node N3), along with instructions that are configured to cause the node to update the content attribute value on the node. For example, if the network node is a website or news server, the instructions can cause the website or news server to update the content attribute value. If the attribute value is quantitative market value, then the instructions can cause the website or server to change the price charged to access the content item to the updated quantitative market value.

Content attributes corresponding to content items can also be stored in a database, such as a content database. For example, current prices for content items across the network can be stored in a content price database. In this case, the updated value of the content attribute 901C can alternatively or additionally be transmitted to the content attribute database. For example, if the content attribute is the quantitative market value of the content, then the updated QMV can be sent to the content attribute database.

Returning to FIG. 1, the process of determining a value of a content attribute, applying a synchronization function to update the value, and transmitting instructions configured to designate the updated value as the current value of the content attribute repeats again at a later time. Although this later time is designated as T+1, the time interval can be configured to be any time interval. The time interval can also be customized to the content attribute, such that the values of certain content attributes are updated more frequently or less frequently than other content attributes. The time interval can also be a learned interval that is determined by a model based on training data and/or network interactions and real-time data. For example, a model can determine that content price for certain types of content (e.g., financial advice) should be updated every hour, whereas the content price for other types of content (e.g., cooking recipes) should be updated once a day. This determination can be based on demand for different types of content, as measured by network traffic and requests.

As shown in FIG. 1, the content attribute value corresponding to an item of content can be determined on a recurring basis over multiple time intervals. The content attribute value can also change based on network activity corresponding to the content. For example, when the content attribute is quantitative market value, the QMV can be updated based on real-time demand information as detected on the network. If a particular item of content has very high traffic and network requests, there may be room for the attribute determination model to raise the current price of the content and thereby further optimize a utility function for maximizing revenue. On the other hand, if web traffic to a content item has decreased dramatically, there may be less room for the attribute determination model to raise the current price of the content.

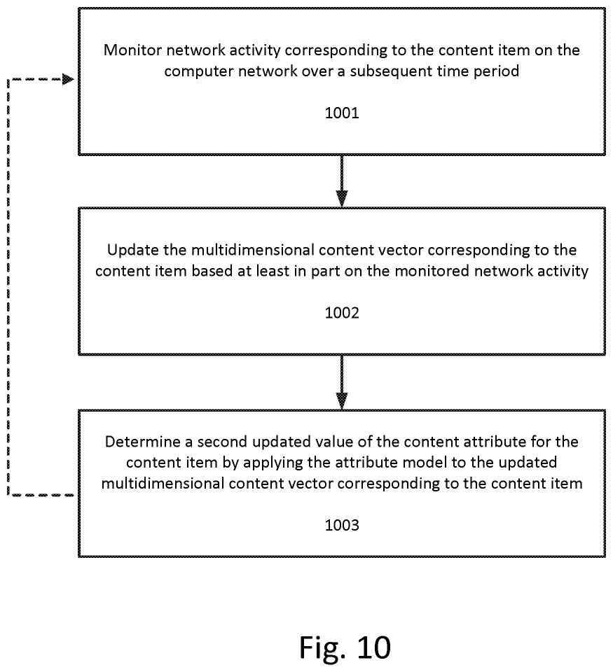

FIG. 10 illustrates a flowchart for updating a content attribute value based on monitored network activity according to an exemplary embodiment.

At step 1001 network activity corresponding to the content item on the computer network is monitored over a subsequent time period. Monitoring can include monitoring one or more network nodes on the network, including content consumption metrics, content viewing metrics, content lifecycle information. This step can include monitoring when content is requested, accessed, or purchased.

At step 1002 the multidimensional content vector corresponding to the content item is updated based at least in part on the monitored network activity. As discussed above, the monitored data can include content consumption data and can be used to update content consumption metrics. The updated data can then be encoded to generate a new/updated multidimensional content vector corresponding to the content item.

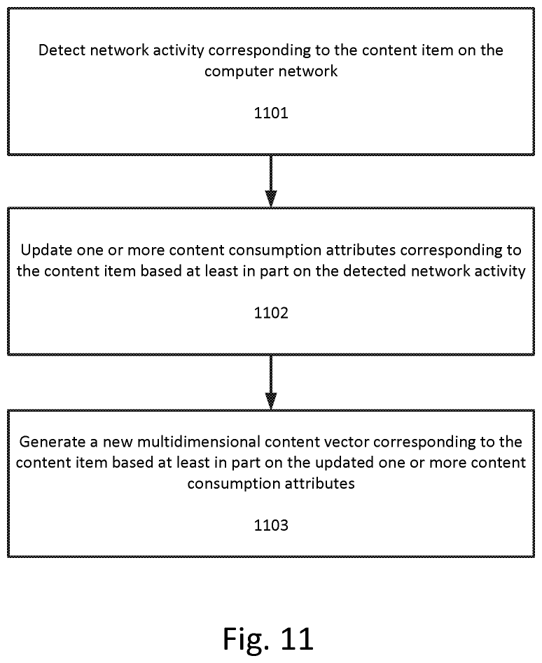

FIG. 11 illustrates a flowchart for updating the multidimensional content vector corresponding to the content item based at least in part on the monitored network activity according to an exemplary embodiment.

At step 1101 network activity corresponding to the content item is detected on the computer network. The network activity can include, for example, content access, content download, content purchase, content sharing, or some other activity on the network pertaining to the content.

At step 1102 one or more content consumption attributes corresponding to the content item are updated based at least in part on the detected network activity. The content consumption attributes can be stored in a content consumption database which stores various content metrics corresponding to different items of content on the network.

At step 1103 a new multidimensional content vector corresponding to the content item is generated based at least in part on the updated one or more content consumption attributes. As discussed previously, the multidimensional content vector corresponds to the content item and incorporates many features/attributes from various sources, including the content genome database, content consumption database, content valuation database, and content cross-database analytics.

Returning to FIG. 10, at step 1003 a second updated value of the content attribute for the content item is determined by applying the attribute determination model to the updated multidimensional content vector corresponding to the content item. Optionally, after determining the second updated value of the content attribute, the synchronization function including the one or more synchronization constraints can be applied to the second updated value to align the updated attribute value with attribute values of related content items (e.g., identical or similar content items) and constrain the attribute value to within a threshold deviation from attribute values of related content items. The synchronization process is described in greater detail previously and can be repeated again with the second updated value of the content attribute.

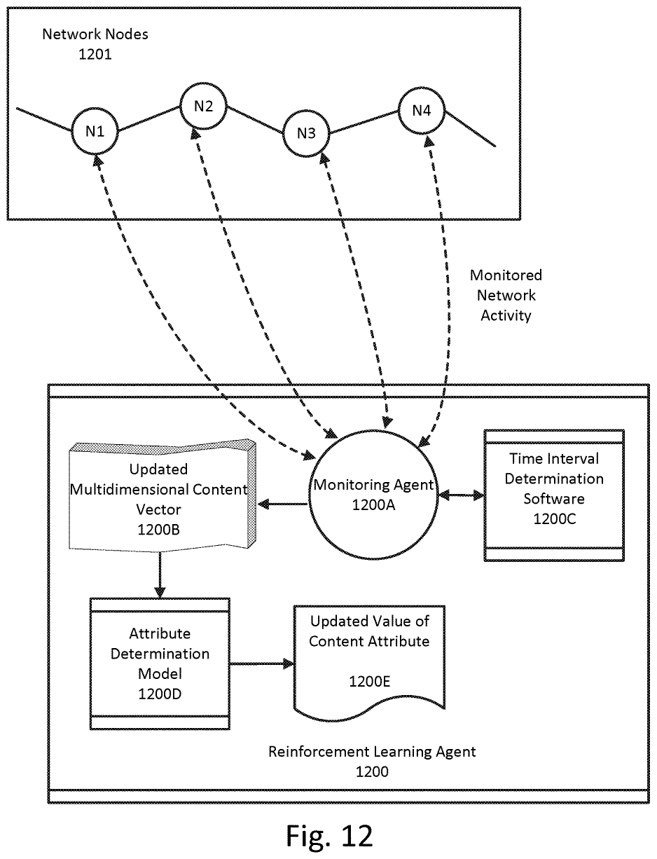

FIG. 12 illustrates a system chart showing the network monitoring process according to an exemplary embodiment. A monitoring agent 1200A on the reinforcement learning agent 1200 monitors network activity on various network nodes 1201 on the network. system. The monitoring agent 1200A can include a network node, a website plugin, a server, a network appliance, and/or one or more agents executing on one or more network nodes 1201.

The monitoring agent 1200A can log changes to content items, usage or access to content items, changes to locations of content items at specific network nodes, and various content consumption metrics. For example, the monitoring agent can include various website plugins on content publisher websites or other websites that collect the relevant data and provide it to the monitoring agent software 1200A on the reinforcement learning agent 1200.

The monitored network activity that is collected by the monitoring agent 1200A is used to generate updated multidimensional content vector 1200B, as described previously. The updated multidimensional content vector 1200B is then input to attribute determination model 1200D to generate an updated value of the content attribute 1200E.

As shown in FIG. 12, the monitoring agent 1200A can communicate with a time interval determination software 1200C. The time interval determination software 1200C determines an appropriate time interval to assess or monitor network nodes 1201 based on the monitored network activity. For example, the monitored network activity can indicate a very low level of baseline activity such that data is only required to be gathered from the network nodes 1201 weekly or monthly. On the other hand, the monitored network activity can be frequent enough to warrant daily or hourly data collection and/or network monitoring. The time interval determination software 1200C informs monitoring agent 1200A of the appropriate interval and monitoring agent 1200A can then conduct monitoring according to the determined time interval. Time interval determination software 1200C can also determine the appropriate time interval for repeating the steps shown in FIG. 1.

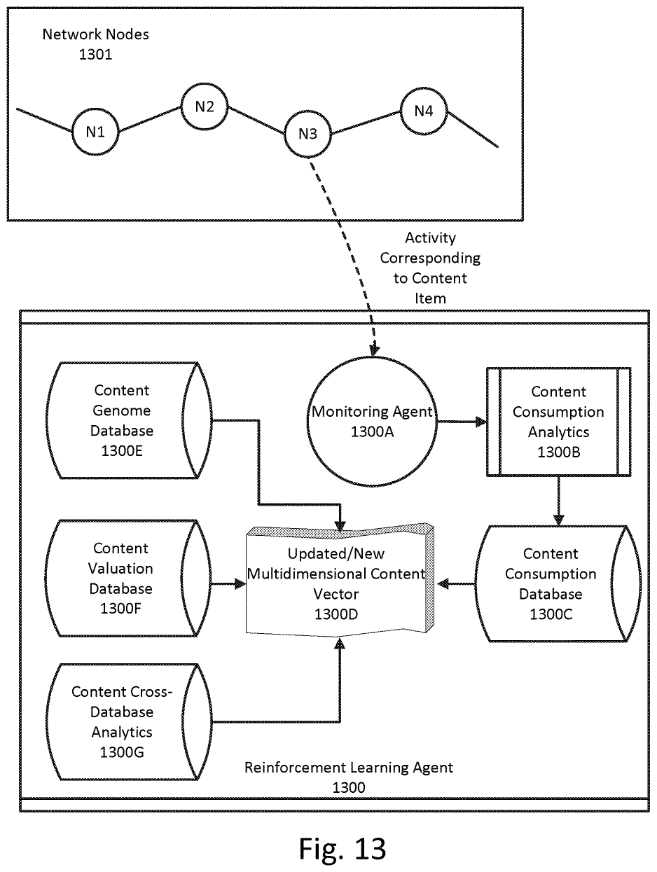

FIG. 13 illustrates a system diagram for monitoring network nodes, detecting activity corresponding to content items, and generating an updated multidimensional content vector according to an exemplary embodiment.

Monitoring agent 1300A on reinforcement learning agent can detect activity corresponding to content item on network nodes 1301, and in particular, on network node N3. The monitoring agent 1300A can then provide the detected activity and/or monitored data to content consumption analytics process 1300B, which itself updates the content consumption database 1300C. The content consumption database 1300C, content genome database 1300E, content valuation database 1300F, and content cross-database analytics database 1300G are then utilized to generate the updated/new multidimensional content vector 1300D.

The monitoring agent 1300A can implement demand analysis functionality and external event monitoring functionality.

The demand analysis functionality utilizes techniques including econometrics, microeconomics, supply and demand models, predictive modelling, behavioral economics, and network theory. These are described in greater detail below:
Econometrics: Applying statistical methods to economic data to test hypotheses and forecast future trends, e.g., using time series econometric models like VAR (Vector Autoregression) to predict demand.
Microeconomics: Studying the behavior of individuals and firms in making decisions regarding the allocation of resources, e.g., analyzing consumer choice theory and production functions.
Supply and Demand Models: Understanding how changes in supply and demand affect prices and quantities in a market, e.g., using equilibrium models to predict the impact of external shocks.
Predictive Modelling: Techniques to predict future demand based on historical data, e.g., using machine learning models like random forests or neural networks.
Behavioral Economics: Studying the effects of psychological factors on economic decisions, e.g., understanding how consumer biases affect demand.
Network Theory: Analyzing interconnected systems and their behavior, e.g., studying how information spreads through social networks and impacts demand.

The external event monitoring functionality utilizes techniques including time series analysis, statistical analysis, natural language processing (nlp), anomaly detection. These are described in greater detail below:
Time Series Analysis: Monitoring trends and detecting seasonal patterns in external event data, e.g., using moving averages and spectral analysis.
Statistical Analysis: Identifying correlations and causal relationships between external events and information stability, e.g., using Granger causality tests.
Natural Language Processing: Techniques like tokenization, named entity recognition, and topic modelling to analyze and extract insights from textual data sources such as news articles, social media, and reports.
Anomaly Detection: Identifying unusual patterns or outliers in data, e.g., using z-scores or clustering-based methods to detect unexpected spikes in demand or changes in information relevance

As discussed previously, the data monitored by the monitoring agent 1300A can include data indicating demand for the content item and popularity of the content item at different points in time, such as network traffic, downloads, reviews, ratings, feedback, website visits, clicks, comments, or other data indicating how many users are accessing the content or requesting the content.

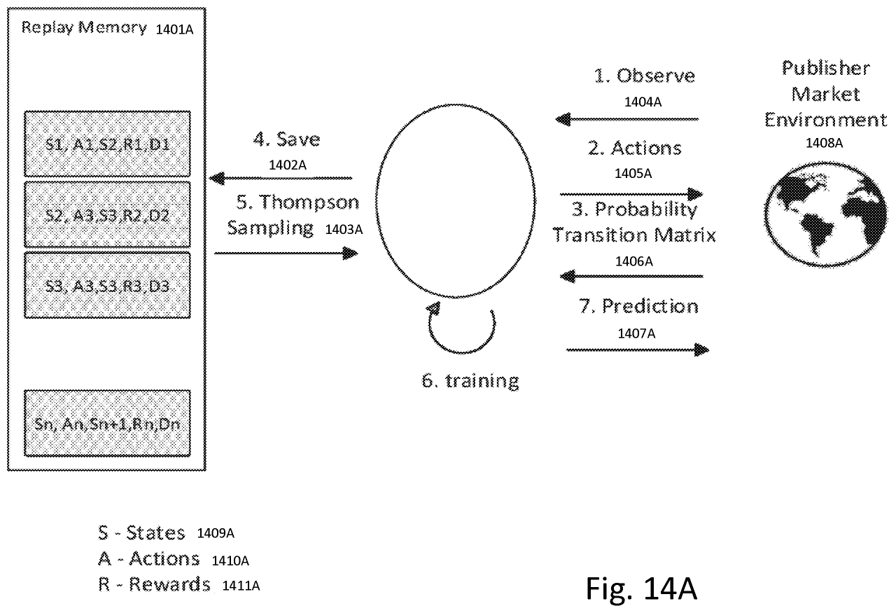

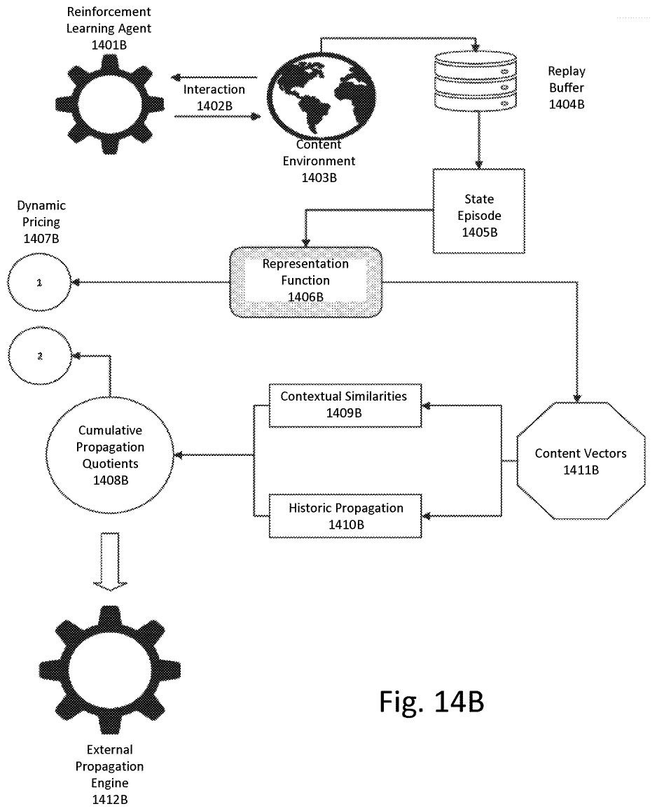

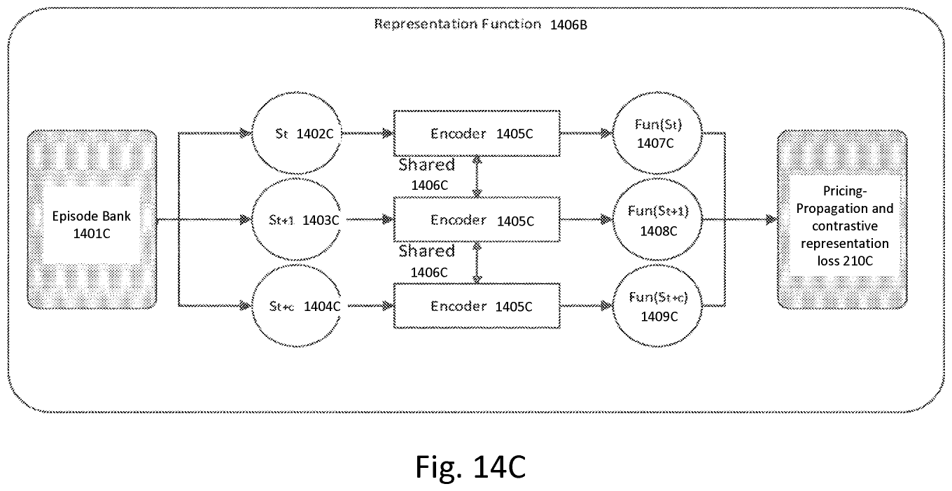

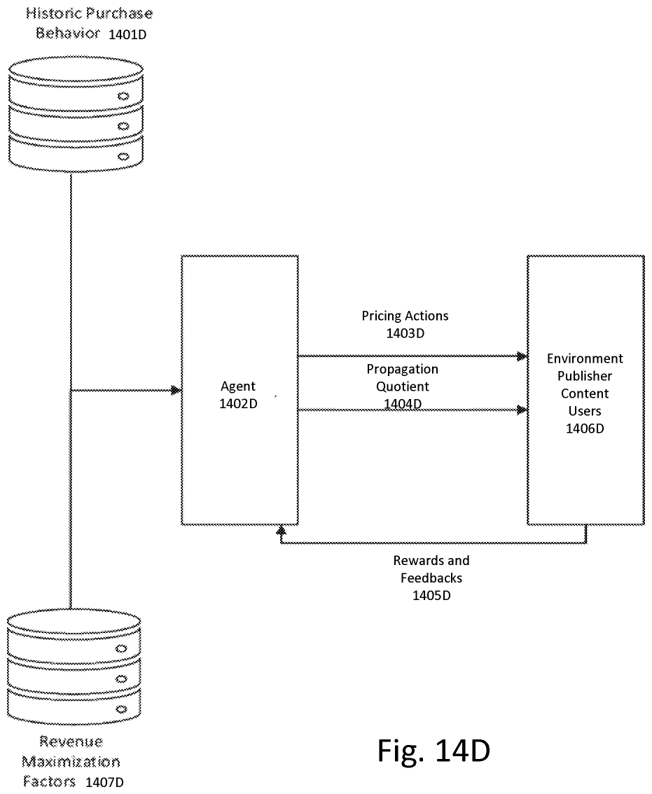

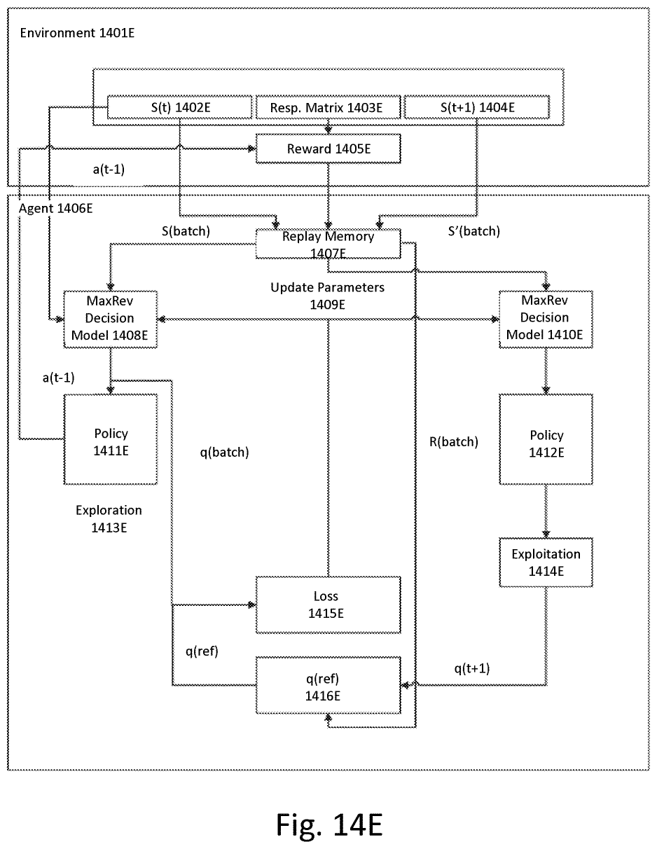

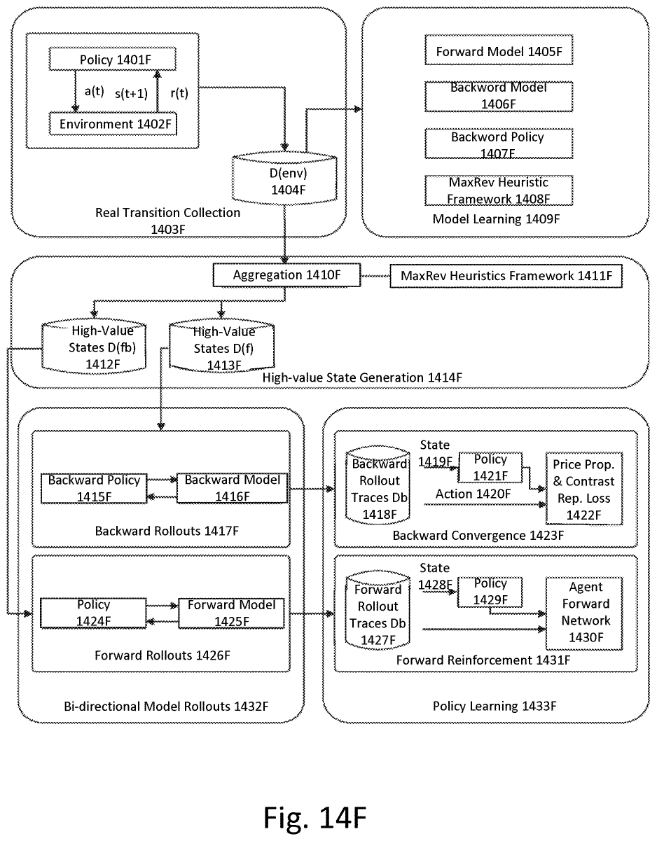

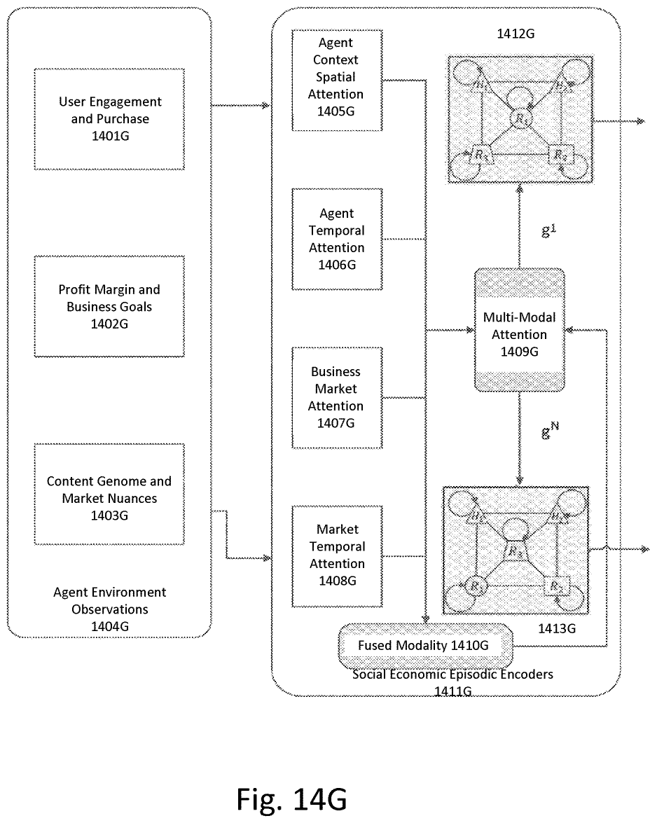

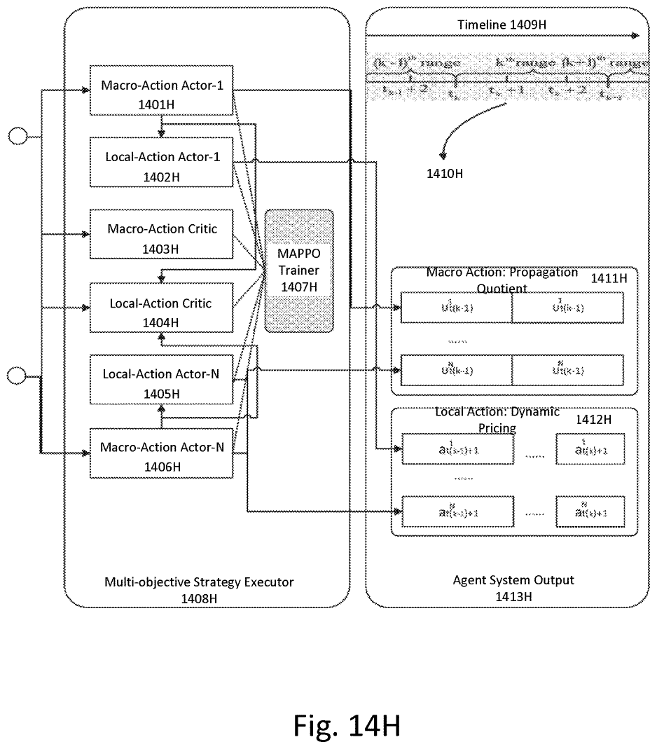

Additional aspects of the present system, the reinforcement learning agent, and the process of determining the current value of a content attribute are described below with respect to FIG. 14A-14H. As explained below, these figures pertain to the scenario where the content attribute that is being optimized is the quantitative market value of the content (e.g. the price).

FIG. 14A illustrates a process performed by the reinforcement learning agent to progressively refine its policy according to an exemplary embodiment. The steps of FIG. 14A are described below.

Step 1—Observe (1404A) The agent looks at the current state of the Publisher Market Environment. This includes market signals such as content pricing, user engagement, demand patterns, and competitive context.

Step 2—Actions (1405A) Based on its current policy, the agent selects and sends an action into the environment—for example, a pricing decision, a pay-window classification, or a boost factor for a piece of digital content.

Step 3—Probability Transition Matrix (1406A) The environment responds by returning a Probability Transition Matrix—a structured representation of the likelihood of moving from the current state to a next state, given the action taken. This encodes market dynamics mathematically.

Step 4—Save (1402A) The full experience tuple (Sn, An, Sn+1, Rn, Dn)—capturing current state, action taken, next state, reward received, and whether the episode is done—is saved into the Replay Memory 1401A for future learning use.

Step 5—Thompson Sampling (1403A) The agent draws a batch of past experiences from the Replay Memory using Thompson Sampling-a Bayesian probabilistic strategy that intelligently balances:
Exploration—trying new, uncertain pricing actions
Exploitation—leveraging already-learned profitable strategies

Step 6—Training The sampled batch from Replay Memory is used to train the agent's neural network. The agent updates its internal parameters to improve future decision-making, learning from both recent and historical experiences simultaneously.

Step 7—Prediction (1407A) The now-updated agent sends a Prediction back into the Publisher Market Environment—a forward-looking valuation, pricing signal, or content decision that the marketplace can act upon.

The agent continuously cycles through Steps 1→7, progressively refining its policy with each iteration until it converges toward optimal content pricing and valuation decisions.

FIG. 14B illustrates a process for generating content vectors and pricing outputs according to an exemplary embodiment. The steps of this figure are described in greater detail below.

Step 1—Agent-Environment Interaction (1402B). The Agent (1401B) engages in a two-way Interaction (1402B) with the Content Environment (1403B). The agent sends pricing or valuation decisions into the environment, and the environment sends back state observations-market signals, user responses, and content performance data.

Step 2—Experience Stored in Replay Buffer (1404B). Every interaction episode between the agent and the Content Environment is recorded and stored in the Replay Buffer (1404B). This database accumulates a growing history of market interactions for offline and batch learning.

Step 3—State Episode Extraction (1405B). From the Replay Buffer, a State Episode (1405B) is extracted-a structured, time-stamped snapshot capturing the precise market conditions, content state, and agent actions at a given moment. This becomes the input to the next stage.

Step 4—Representation Function (1406B). The State Episode is passed through the Representation Function (1406B)—the central processing module of FIG. 14B. This function transforms raw state data into structured, meaningful representations that the system can use to compute pricing decisions and similarity relationships. It receives inputs from both the State Episode (1405B) and feeds outputs in two directions: toward Dynamic Pricing and toward Content Vectors.

Step 5—Content Vectors Generated (1411B). The Representation Function outputs Content Vectors (1411B)—high-dimensional numerical embeddings that encode the semantic, quality, and market attributes of each digital content item. These vectors are the mathematical fingerprint of the content, enabling quantitative comparison between articles.

Step 6—Contextual Similarities Computed (1409B). The Content Vectors (1411B) feed into Contextual Similarities (1409B), which computes how similar one piece of content is to others currently in the marketplace. This is the mechanism behind the CARL synchronization constraint-similar content should have aligned pricing values.

Step 7—Historic Propagation Retrieved (1410B). In parallel, the Content Vectors also feed into Historic Propagation (1410B), which looks up how pricing decisions have historically spread across similar content items. This gives the system a memory of past pricing ripple effects.

Step 8—Cumulative Propagation Quotients Aggregated (1408B). Both Contextual Similarities (1409B) and Historic Propagation (1410B) feed into the Cumulative Propagation Quotients (1408B). This module aggregates the similarity-weighted, history-informed pricing spread factors into a single cumulative score that governs how a pricing decision on one content item should propagate to related items.

Step 9—Dynamic Pricing Output—Node 1 (1407B). The Representation Function (1406B) directly outputs the first Dynamic Pricing decision—Node 1—representing the immediate, individual content price recommendation generated for the specific content item being evaluated.

Step 10—Dynamic Pricing Output—Node 2 (1407B). The Cumulative Propagation Quotients (1408B) feed into Node 2—the second Dynamic Pricing output, which represents the propagation-adjusted price—accounting for market coherence, similar-content alignment, and historical spread patterns.

Step 11—External Propagation Engine Triggered (1412B). Both Dynamic Pricing outputs (Nodes 1 and 2) flow downward into the External Propagation Engine (1412B)—a downstream gear-shaped system that broadcasts the finalized pricing decisions across the publisher platform, applying them to all contextually similar content items simultaneously.

FIG. 14C illustrates a process for training an encoder according to an exemplary embodiment. The steps of this figure are described in greater detail below.

Step 1—Episode Bank as Source (1401C). The entire process can begin with the Episode Bank (1401C)—a structured repository of previously collected market interaction episodes. This acts as the training data source, supplying temporally ordered sequences of states experienced by the reinforcement learning agent in the Content Environment.

Step 2—Three States Extracted Simultaneously From each episode in the bank and three distinct temporal snapshots of the market state are extracted in parallel:
St (1402C)—the state at the current timestep t
St+1 (1403C)—the state one timestep later (the immediate next state)
St+c (1404C)—a state that is c timesteps ahead (a contextually related but temporally distant state)

This triplet structure is deliberate—it allows the system to learn both short-range and long-range content market relationships simultaneously.

Step 3—Each State Passed Through Its Own Encoder (1405C). Each of the three states is independently passed through an Encoder (1405C)—a neural network that transforms the raw state data into a compact, dense latent representation. There are three encoder instances shown, one per state.

Step 4—Encoders Share Weights (1406C). Critically, all three encoders are Shared (1406C)—meaning they use identical, synchronized parameters. This is a key architectural decision: by forcing all three temporal states through the same encoder, the system ensures that the learned representations are directly comparable to one another in the same latent space, enabling meaningful distance and similarity computations.

Step 5—Encoded Representations Produced. Each encoder produces a functional representation of its input state:
Fun(St) 1407C—the latent encoding of the current state
Fun(St+1) 1408C—the latent encoding of the next state
Fun(St+c) 1409C—the latent encoding of the contextually distant state

These three output vectors now live in the same learned embedding space, making them directly comparable.

Step 6—Pricing-Propagation and Contrastive Representation Loss Computed (210C). All three encoded representations—Fun(St), Fun(St+1), and Fun(St+c)—are fed jointly into the Pricing-Propagation and Contrastive Representation Loss module (210C). This combined loss function does two things simultaneously:

Pricing-Propagation loss—ensures the learned representations correctly capture how pricing decisions flow and propagate across temporally adjacent content states

Contrastive representation loss—pulls the representations of similar/related states (St and St+1) closer together in latent space, while pushing dissimilar or distant states (St+c when contextually different) further apart

Step 7—Loss Drives Encoder Weight Updates. The computed combined loss (1410C) is backpropagated through all three shared encoders simultaneously, updating their shared weights. This trains the Representation Function to produce embeddings that are simultaneously pricing-aware and market-coherent.

Step 8—Output Fed Back to FIG. 14B. The trained Representation Function (1406B as named in FIG. 14B) now produces high-quality content state embeddings that feed into the Content Vectors, Contextual Similarities, and Dynamic Pricing pipeline described in FIG. 14B.

FIG. 14D illustrates a reward and feedback process for revenue maximization according to an exemplary embodiment. The steps of this figure are explained below.

Step 1—Historic Purchase Behavior Fed to Agent (1401D). The Historic Purchase Behavior database (1401D) provides the agent with a rich record of past user buying patterns—including what content was purchased, at what price points, by which user segments, and under what market conditions. This gives the agent a foundational understanding of demand elasticity and user price sensitivity before it makes any new decisions.

Step 2—Revenue Maximization Factors Fed to Agent (1407D). Simultaneously, the Revenue Maximization Factors database (1407D) feeds the agent a second stream of business-critical parameters. These include factors such as desired profit margins, publisher agreements, price windows, loss recovery percentages, distribution channel strategies, and psychological pricing strategies. Together with historic purchase behavior, these form the agent's complete decision-making context.

Step 3—Agent Processes Both Inputs (1402D). The Agent (1402D) ingests both data streams-historic purchase behavior and revenue maximization factors- and computes two distinct outputs simultaneously. The agent's policy, shaped by prior training, determines how to balance individual content pricing against market-wide propagation coherence/synchronization.

Step 4—Pricing Actions Dispatched (1403D). The agent sends Pricing Actions (1403D) to the Environment. These are the direct, individual content price decisions—the specific price value assigned to a particular digital content item at this moment in time, optimized based on the revenue maximization factors and purchase history.

Step 5—Propagation Quotient Dispatched (1404D). Alongside the pricing action, the agent simultaneously dispatches the Propagation Quotient (1404D) to the Environment. This is a computed multiplier or factor that governs how the pricing decision should ripple outward to contextually similar content items-encoding the synchronization constraint that similar content should maintain coherent pricing relationships.

Step 6—Environment Receives Both Signals (1406D). The Environment Publisher Content Users (1406D) receives both the Pricing Actions and the Propagation Quotient together. This combined signal allows the environment to:
Apply the direct price to the specific content item
Propagate adjusted pricing across similar/related content items on the publisher platform
Present updated prices to end users in real time

Step 7—Rewards and Feedbacks Returned (1405D). After the pricing decisions take effect in the marketplace, the Environment sends back Rewards and Feedbacks (1405D) to the Agent. These signals encode the market's response-whether users purchased at the new price, whether revenue increased, whether the propagated prices held coherence, and whether the publisher's business goals were met.

Step 8—Agent Updates Its Policy. The returned rewards and feedbacks close the loop, allowing the Agent (1402D) to update its internal policy. Strong positive rewards reinforce the pricing strategy used; negative signals trigger policy adjustment. Combined with the continuously refreshed Historic Purchase Behavior (1401D) and Revenue Maximization Factors (1407D), this creates a perpetually self-improving pricing system.

FIG. 14E illustrates a chart for stabilizing a policy using dual networks according to an exemplary embodiment. The steps of this figure are explained below.

Step 1—Environment Generates State Transition. Environment (1401E) produces current state St (1402E), next state St+1 (1404E), and a Response Matrix (1403E). Together these compute the Reward (1405E) for the previous action a_t−1.

Step 2—Experience Stored in Replay Memory (1407E). The reward, along with state batch Sbatch and next-state batch S′batch, is stored in Replay Memory (1407E) for batch sampling.

Step 3—Left Network Handles Exploration (1408E→1411E→1413E). MaxRev Decision Model 1408E (the online network) receives Sbatch, generates Q-values (q_batch), and its Policy 1411E selects actions via Exploration (1413E)—trying potentially new, higher-revenue pricing strategies. The chosen action a_t−1 feeds back into the Environment.

Step 4—Right Network Handles Exploitation (1410E→1412E→1414E). MaxRev Decision Model 1410E (the target network) receives S′batch and Rbatch, and its Policy 1412E selects actions via Exploitation (1414E)—using the most reliably profitable known pricing decisions. It outputs q_t+1 as stable future Q-value estimates.

Step 5—Reference Q-Values Stored (q_ref 1416E). The target network's q_t+1 is stored in q_ref (1416E)—a stable reference buffer that holds recent best-known Q-values without being disrupted by rapid online learning updates.

Step 6—Loss Computed (1415E). Loss (1415E) is calculated by comparing q_batch (online network's predictions) against q_ref (target network's stable reference values). This difference drives the learning signal.

Step 7—Parameters Updated (1409E). Update Parameters (1409E) uses the loss to update both networks—the online network (1408E) updates frequently via gradient descent, while the target network (1410E) updates more slowly, maintaining stability.

FIG. 14F illustrates a process for enriching a policy via bi-directional rollouts according to an exemplary embodiment. The steps of this figure are explained in greater detailed below.

Step 1—Real Transition Collection (1403F). Policy (1401F) interacts with Environment (1402F), generating real transitions (action at, next state Sₜ₊₁, reward rₜ), stored in D_env (1404F).

Step 2—Model Learning (1409F). D_env trains four components in parallel: Forward Model (1405F), Backward Model (1406F), Backward Policy (1407F), and MaxRev Heuristic Framework (1408F)—building a full world model of the content market.

Step 3—Aggregation (1410F). Real transition data (D_env) is combined with MaxRev Heuristics Framework (1411F) outputs at the Aggregation node (1410F)—merging empirical market data with revenue-optimization heuristics.

Step 4—High-value State Generation (1414F). Aggregated data is filtered into two databases-High-value States Db (1412F) and High-value States Df (1413F)—retaining only market states that are most relevant to revenue maximization for use in rollouts.

Step 5—Backward Rollouts (1417F). Backward Policy (1415F) and Backward Model (1416F) work together to simulate rollouts in reverse—starting from high-value states and working backwards to understand what conditions led to them. Traces are stored in Backward Rollout Traces Db (1418F).

Step 6—Forward Rollouts (1426F). Policy (1424F) and Forward Model (225F) simulate rollouts forward from high-value states—projecting future market trajectories. Traces stored in Forward Rollout Traces Df (1427F).

Step 7—Backward Convergence (1423F). Backward rollout traces (State 1419F, Action 1420F) feed through Policy 1421F to compute Price Propagation & Contrastive Representation Loss (1422F)—refining pricing coherence across similar content.

Step 8—Forward Reinforcement (1431F). Forward rollout traces (State 1428F) feed through Policy 1429F into the Forward Network (1430F)—training the agent on projected future market outcomes.

Step 9—Policy Learning (1433F). Both Backward Convergence and Forward Reinforcement outputs jointly drive Policy Learning (1433F)—the final stage that consolidates all learned signals into an updated, robust pricing policy.

FIG. 14G illustrates the process for producing a rich fused state representation that feeds the agent according to an exemplary embodiment. The steps of this figure are explained in greater detailed below.

Step 1—Three Input Streams Defined (1404G). The agent observes three distinct data categories from the environment:
User Engagement and Purchase (1401G). Behavioral signals: clicks, purchases, session time.

Profit Margin and Business Goals (1402G). Revenue targets, pricing constraints, publisher agreements.

Content Genome and Market Nuances (1403G). Content attributes, quality scores, market context.

Step 2—Four Attention Modules Applied Each input stream is routed through specialized attention mechanisms:

Agent Context Spatial Attention (1405G). Captures spatial/structural relationships in user engagement data.

Agent Temporal Attention (1406G). Captures how user behavior evolves over time.

Business Market Cross Attention (1407G). Cross-references business goals against market signals.

Market Temporal Attention (1408G). Tracks how market conditions shift over time.

Step 3—Multi-Modal Attention Fusion (1409G). All four attention outputs converge at Multi-Modal Attention (1409G)—the central hub that learns how to weight and combine signals from all modalities. It operates iteratively across g¹ through g^{N} passes, progressively refining the fused representation.

Step 4—Upper Graph Network Processing (1412G). The first fusion pass g¹ feeds into the upper Graph Network (1412G), where nodes H₁, H₂ represent head attention nodes and R₁, R₂, R₃ represent relational nodes. This graph structure models the complex interdependencies between content items, users, and market variables at one level of abstraction.

Step 5—Lower Graph Network Processing (1413G). After N fusion passes g^{N}, a second, deeper Graph Network (1413G) processes the further-refined representation—capturing higher-order market relationships and pricing dependencies across the content ecosystem.

Step 6—Fused Modality Output (1410G). Outputs from both graph networks and all attention passes are merged into Fused Modality (1410G)—a single, rich latent representation that encodes user behavior, business objectives, content attributes, and market dynamics together in one unified vector.

Step 7—Output to Downstream Components. The Fused Modality feeds downstream into the CARL pricing and propagation pipeline—providing a holistic, multidimensional state representation for the agent's decision-making.

FIG. 14H illustrates a final execution layer configured to consume upstream components to deliver propagation quotients and dynamic pricing as output. The steps of this figure are explained in greater detailed below.

Step 1—Hierarchical Actor Structure The executor contains N sets of paired actors operating at two levels:
Macro-Action Actors (1401H, 1406H)—decide high-level, market-wide propagation strategy
Local-Action Actors (1402H, 1405H)—decide granular, per-content dynamic pricing

Step 2—Critic Evaluation Two critics evaluate the quality of decisions:
Macro-Action Critic (1403H)—assesses the value of macro/propagation decisions
Local-Action Critic (1404H)—assesses the value of local/pricing decisions

Step 3—MAPPO Trainer Coordinates All (1407H). The MAPPO Trainer (Multi-Agent Proximal Policy Optimization) receives inputs from all actors and critics simultaneously, coordinating their joint training. Dashed lines show the cross-connections between all components, enabling multi-agent cooperative learning.

Step 4—Timeline Defines Action Ranges (1409H). The Timeline (1409H) divides decisions into discrete temporal ranges—(k−1)^{th}, k^{th}, (k+1)^{th}—each spanning multiple timesteps (tₖ, tₖ₊₁, tₖ₊₂ . . . ). Macro actions span entire ranges while local actions operate within each timestep inside a range.

Step 5—Macro Output: Propagation Quotients (1411H). MAPPO outputs Propagation Quotients Uᵢt(k−1) for agents 1 through N—the market-wide pricing spread factors applied across similar content items for each temporal range.

Step 6—Local Output: Dynamic Pricing (1412H). Simultaneously, MAPPO outputs granular Dynamic Pricingdecisions aⁱt(k−1)+1 through aⁱt(k)+1 for all N agents—the specific per-content price values at each individual timestep within the range.

Step 7—System Output (1413H). Both macro propagation quotients and local dynamic pricing decisions together form the complete System Output-delivered in a structured, time-indexed grid covering all agents across all temporal ranges.

FIGS. 14A-14H form a layered pipeline. In particular:
FIG. 14C trains the encoder→used by 14B to generate content vectors and pricing outputs;
14A+14D supply interaction data and reward signals;
14E stabilizes the policy using dual networks;
14F enriches the policy further via bi-directional rollouts;
14G produces the rich fused state representation that feeds the agent in
14E and 14H; and
14H is the final execution layer—consuming all upstream components to deliver propagation quotients and dynamic pricing as system output.

As is apparent from the disclosure above, the CARL system can be utilized to generate a price for content that is distinct from QMV price and also distinct from adaptive pricing based on demand/traffic. The QMV can take into account market value of similar content, but does not determine prices that maximize a particular utility function, such as revenue maximization and does not utilize prices of related content items as guardrails in a synchronization process. Additionally, adaptive pricing adjusts price based on demand/network traffic, whereas CARL effectively models purchase behavior to determine pricing changes that maximize a utility function of revenue maximization.

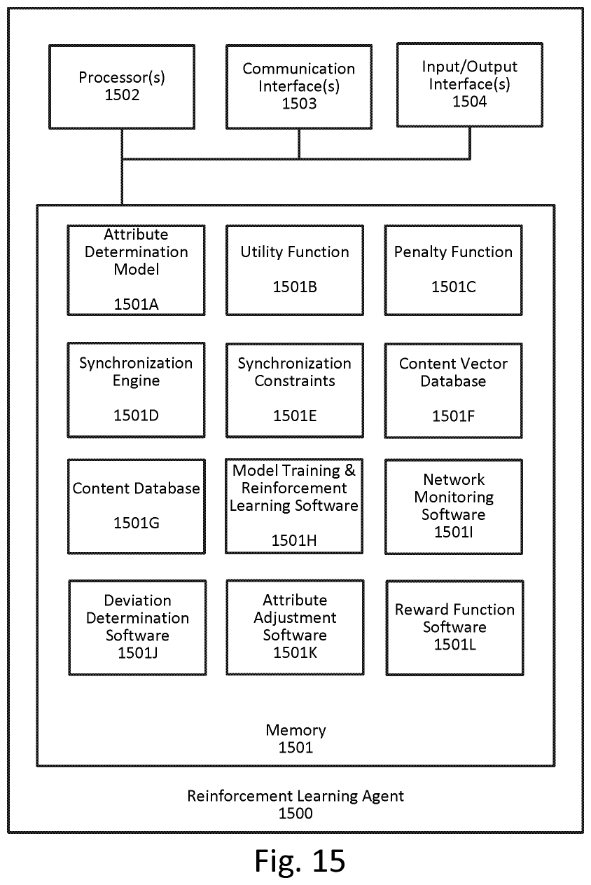

FIG. 15 illustrates the components of a reinforcement learning agent configured to perform the processes described herein. Reinforcement learning agent 1500 is a computing device that includes a memory 1501 that is a non-transitory computer-readable medium and can be volatile memory (e.g., registers, cache, RAM), non-volatile memory (e.g., ROM, EEPROM, flash memory, etc.), or some combination of the two.

As shown in FIG. 15, memory 1501 can include attribute determination model 1501A, utility function 1501B, penalty function 1501C, synchronization engine 1501D, synchronization constraints 1501E, content vector database 1501F, content database 1501G, model training and reinforcement learning software 1501H, network monitoring software 1501I, deviation determination software 1501J, attribute adjustment software 1501K, and/or reward function software 1501L, as described herein. Each of the software components in memory 1501 store specialized instructions and data structures configured to perform the corresponding functionality and techniques described herein.

All of the software stored within memory 1501 can be stored as a computer-readable instructions, that when executed by one or more processors 1502, cause the processors to perform the functionality described with respect to FIGS. 1-14.

Processor(s) 1502 execute computer-executable instructions and can be real or virtual processors. In a multi-processing system, multiple processors or multicore processors can be used to execute computer-executable instructions to increase processing power and/or to execute certain software in parallel.

Reinforcement learning agent 1500 additionally includes a communication interface 1503, such as a network interface, which is used to communicate with devices, applications, or processes on a computer network or computing system, collect data from devices on a network, and implement encryption/decryption actions on network communications within the computer network or on data stored in databases of the computer network. The communication interface conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Reinforcement learning agent 1500 further includes input and output interfaces 1504 that allow users (such as system administrators) to provide input to the system to set parameters, to edit data stored in memory 1501, or to perform other administrative functions.

An interconnection mechanism (shown as a solid line in FIG. 15), such as a bus, controller, or network interconnects the components of the reinforcement learning agent 1500.

Input and output interfaces 1504 can be coupled to input and output devices. For example, Universal Serial Bus (USB) ports can allow for the connection of a keyboard, mouse, pen, trackball, touch screen, or game controller, a voice input device, a scanning device, a digital camera, remote control, or another device that provides input to the reinforcement learning agent 1500.

Reinforcement learning agent 1500 can additionally utilize a removable or non-removable storage, such as magnetic disks, magnetic tapes or cassettes, CD-ROMs, CD-RWs, DVDs, USB drives, or any other medium which can be used to store information and which can be accessed within the reinforcement learning agent 1500.

The processes and systems described herein can be used in biotechnology for drug development and targeted therapies, In biotechnology, optimizing drug development processes involves managing various molecules or compounds that share similarities. Aligning values of similar molecules while optimizing for their efficacy; safety, or specific therapeutic properties could enhance the drug development pipeline.

The processes and systems described herein can be used in sports or athlete performance tracking and training. In sports, optimizing athlete performance involves synchronizing performance metrics among similar athlete profiles. Maximizing performance while ensuring that training strategies or techniques align for athletes with similar attributes could help in personalized training programs.

The processes and systems described herein can be used in agricultural crop yield optimization. In the agricultural sector, optimizing crop yields. involves managing different varieties of crops or seeds with similar characteristics. Synchronizing values of similar seeds while maximizing yield, resistance to diseases, or nutritional value could improve agricultural productivity,

The processes and systems described herein can be used in retail assortment planning and inventory management. Retail businesses can optimize their product assortment by synchronizing values for similar products or SKUs within a category. Maximizing sales or profitability while ensuring coherence in the value or perception of similar products could enhance inventory management strategies.

The processes and systems described herein can be implemented as an AI in a Box, comprising a self-contained Al controlled environment designed to facilitate seamless processing of input data and generation of output data through an encapsulated infrastructure. The Box can encompass a containerized framework housing specialized application software CARL Application instances and management software, tailored to harness the capabilities of artificial intelligence. The infrastructure within the ‘Box’ comprises infrastructure or operating System or GPU which further comprises computational resources, storage systems, and networking components configured to enable data ingestion, processing, and output generation. The container encapsulates a cohesive ecosystem wherein CARL algorithms, neural networks, or machine learning models operate efficiently. The application software embedded within the ‘Box’ leverages CARL capabilities to process diverse input data sources, adapt to varying workloads, and generate output data reflective of the Al-driven analysis or decision-making processes. Additionally, the management software can orchestrate and govern the functionalities within the ‘Box) optimizing resource allocation, ensuring security measures, and facilitating the seamless operation of the enclosed Al environment. This self-contained ‘Al in a Box architecture offers a comprehensive solution for processing input data, executing Al-driven operations, and generating output data within a confined and manageable framework.

The processes and systems described herein can be integrated with an innovative API gateway system equipped with a load balancer, providing an interface to manage and route requests across a network of multiple services and endpoints. The API gateway orchestrates incoming requests, utilizing a load balancer mechanism to evenly distribute traffic across a plurality of backend services and endpoints situated behind it. This load balancing functionality ensures optimal resource utilization, enhanced reliability, and improved response times across the network. The system further incorporates a user interface tailored to administer and configure the API gateways routing policies, traffic allocation, and service endpoints. Through this interface, administrators or users can define routing rules, set load balancing strategies, and monitor traffic distribution, offering a: user-friendly platform to manage the API gateways functionalities, Additionally, the API gateway's user interface enables real-time visualization of traffic patterns, endpoint health status, and load distribution, empowering users to make informed decisions regarding network routing, performance optimization, and resource allocation within the system. The seamless integration of a load balances; multiple services, endpoints, and a user-friendly interface within the API gateway presents a comprehensive solution for efficient request handling, load distribution, and network management across diverse service endpoints.

The processes and systems described herein can be include infrastructure for hosting the CARL application instances within containers, leveraging an infrastructure stack comprising foundational components to support efficient deployment and operation. At the foundational layer, the infrastructure provides the underlying hardware resources, including computing, storage, and networking elements. Situated atop the infrastructure is an operating system optimized for containerization, offering a robust environment for running and managing containerized applications. This operating system facilitates the abstraction and isolation required for containers to operate independently of the underlying hardware. There is a container engine, positioned on top of the operating system layer, responsible for orchestrating the creation, execution, and management of containers. The container engine enables the encapsulation of applications and their dependencies into portable, isolated, and lightweight containers.

The processes and systems described herein can include a dedicated hardware system designed specifically for accelerated and optimized artificial intelligence. (Al) processing. This specialized hardware architecture comprises a series of integrated. circuits, processors, and memory units engineered to execute Al algorithms with enhanced efficiency, speed, and scalability. The hardware configuration incorporates parallel processing units tailored for matrix operations, enabling rapid execution of neural network models and complex Al computations. Furthermore, the system includes dedicated instruction sets and optimized data pathways, facilitating seamless integration with Al frameworks and software libraries. The innovation focuses on minimizing latency and maximizing throughput for Al workloads, providing a purpose-built solution to meet the computational demands of Al applications across diverse domains.

The processes and systems described herein can seamlessly integrate and optimize operations within hybrid cloud environments. This innovative technology encompasses a versatile architecture that efficiently interfaces with both private and public cloud infrastructures, enabling dynamic workload distribution, resource allocation, and data management across hybrid cloud deployments. Key aspects include specialized adaptability mechanisms facilitating secure and efficient data exchange between on-premises and off-premises cloud components. The system further comprises dynamic scalability features, allowing for on-demand resource provisioning and elastic scaling across the hybrid cloud landscape. Additionally, the system can incorporate intelligent workload orchestration and policy-based management functionalities, ensuring optimal performance and resource utilization while maintaining compliance with diverse regulatory frameworks. This hybrid cloud support redefines the operational paradigms of cloud computing, offering unparalleled flexibility, scalability, and security for applications and services operating within hybrid cloud environments.

The processes and systems described herein can be deployed in a microservice architecture designed to revolutionize application development and deployment paradigms, This innovative architecture comprises a collection of independently deployable, loosely coupled services, each encapsulating distinct business functionalities or processes. These microservices communicate through well-defined APIs, fostering modularity, flexibility, and scalability within complex software systems. Key aspects of this architecture include the decentralized nature of microservices, allowing for rapid development, deployment, and updating of individual components without impacting the entire system. Furthermore, the invention incorporates sophisticated orchestration and service discovery mechanisms, enabling seamless integration, fault tolerance, and horizontal scaling across distributed computing environments. The innovation also emphasizes the adoption of containerization and container orchestration frameworks, facilitating efficient resource utilization and management. This inventive microservice architecture redefines application design principles, offering enhanced agility, maintainability, and scalability for modern software ecosystems.

The processes and systems described herein can optimize operations within containerized computing environments. This innovative technology encompasses a comprehensive framework designed for seamless orchestration, management, and scalability of container-based applications. Key features of the invention include a robust container orchestration system capable of dynamically deploying, scaling, and managing containerized workloads across distributed computing infrastructures. Furthermore, the system incorporates intelligent resource allocation mechanisms, ensuring efficient utilization of compute, storage, and networking resources while adapting to changing demands and constraints. The invention also integrates advanced containerization technologies, providing isolation, portability, and encapsulation of application components within lightweight, standardized containers. Additionally, the system incorporates comprehensive security measures, including access controls, encryption, and policy enforcement, ensuring the integrity and confidentiality of containerized workloads. This inventive support for container environments redefines the paradigms of application deployment and management, offering enhanced agility, resource efficiency, and scalability for modern computing ecosystems.

The processes and systems described herein can be embodied as an Application Programming interface (API), designed to facilitate seamless integration and interaction with software applications and web applications which require output from a reinforcement learning engine. This API encompasses a set of well-defined functionalities, methods, and protocols allowing external systems, applications, or developers to access, utilize, and leverage the capabilities of reinforcement learning server within their respective environments. Key features of this API include its standardized interfaces, enabling interoperability and ease of integration across diverse software platforms and systems. Furthermore, the API provides comprehensive documentation, exemplar use cases, and development resources, empowering developers to effectively harness the functionalities of reinforcement learning server in their applications. This inventive API framework redefines the accessibility and utilization of reinforcement learning server, offering a standardized, user-friendly interface for harnessing its functionalities across a wide spectrum of applications and industries.

The processes and systems described herein can be embodied as a Software Development Kit (SDK) designed to empower developers, enabling them to seamlessly integra extend, and leverage the functionalities of reinforcement learning server within their software applications. This SDK comprises a comprehensive suite of tools, libraries, APIs, and pre-built modules meticulously crafted to facilitate the swift adoption and utilization of reinforcement learning server capabilities. Key features of this SDK include intuitive interfaces, documentation, and sample codes, fostering ease of implementation and rapid prototyping for developers across diverse platforms and programming languages,

The processes and systems described herein can be integrated with a billing procedure associated with Application Programming interface (API) usage. The system comprises a processor and a memory storing instructions that, when executed by the processor, facilitate the tracking, analysis, and monetization of API interactions. The invention introduces an adaptive billing engine capable of real-time monitoring, analyzing API calls, and computing charges based on predefined or dynamically adjustable pricing models. Furthermore, the system incorporates a user interface enabling clients to access usage metrics, configure billing preferences, and receive transparent, granular billing statements.

The processes and systems described herein can be deployed as Al in a Box, offering a contained environment for seamless integration and operation of artificial intelligence models. The invention encompasses hardware and software components encapsulated within a designated physical or virtual space, providing a secure and isolated ecosystem for Al functionalities. This innovative system leverages a modular architecture, enabling the deployment and execution of diverse Al algorithms, neural networks, or machine learning models within the confined space of the ‘Box.’ The Al in a Box framework facilitates simplified integration into existing Infrastructures, ensuring compatibility and scalability across various industries and applications.

Having described and illustrated the principles of our invention with reference to the described embodiment, it will be recognized that the described embodiment can be modified in arrangement and detail without departing from such principles. It should be understood that the programs, processes, or methods described herein are not related or limited to any particular type of computing environment, unless indicated otherwise. Elements of the described embodiment shown in software may be implemented in hardware and vice versa.

It will be appreciated by those skilled in the art that changes could be made to the embodiments described above without departing from the broad inventive concept thereof. For example, the steps or order of operation of one of the above-described methods could be rearranged or occur in a different series, as understood by those skilled in the art. It is understood, therefore, that this disclosure is not limited to the particular embodiments disclosed, but it is intended to cover modifications within the spirit and scope of the present disclosure as defined by the appended claims.

1. A method executed by one or more computing devices of a reinforcement learning agent for optimizing a current value of a content attribute, the method comprising:
determining a value of a content attribute for a content item on one or more nodes of a computer network by applying an attribute determination model to a multidimensional content vector corresponding to the content item, the attribute determination model being configured to determine the value of the content attribute;
applying a synchronization function comprising one or more synchronization constraints to update the value of the content attribute, the synchronization function being configured to identify one or more related content items on the computer network and update the value of the content attribute to constrain any deviation between the value of the content attribute for the content item and one or more current values of the content attribute for the one or more related content items to within one or more thresholds defined by the one or more synchronization constraints; and
transmitting one or more instructions configured to designate the updated value as a current value of the content attribute for the content item on the one or more nodes of the computer network.

2. The method of claim 1, wherein the synchronization function is configured to identify one or more related content items on the computer network based at least in part on one or more vector similarity measures between the multidimensional content vector corresponding to the content item and one or more multidimensional content vectors corresponding to the one or more related content items.

3. The method of claim 1, wherein the multidimensional content vector comprises a plurality of feature values corresponding to a plurality of features relating to the content item.

4. The method of claim 3, wherein the plurality of features comprise one or more of: content publisher, content provider, content language, content format, content category, content quality, content originality, content bias, content topic engagement, content rating, content seasonality, content value analysis, content user engagement, content domain performance, content user journey analysis, content time spent, content valuation trends, content initial price, content price forecast, content engagement correlation, content return on investment, content performance by language and domain, or content user engagement and valuation forecast.

5. The method of claim 1, wherein the attribute determination model is configured to maximize a utility function and minimize a penalty function and wherein the utility function is derived based at least in part on the content attribute and wherein the penalty function penalizes differences between the determined content attribute value and a reward function content attribute value determined based on a reward function.

6. The method of claim 1, wherein applying a synchronization function comprising one or more synchronization constraints to update the value of the content attribute comprises:
identifying one or more related content items on the computer network based at least in part on one or more vector similarity measures between the multidimensional content vector corresponding to the content item and one or more multidimensional content vectors corresponding to the one or more related content items;
retrieving one or more current values of the content attribute for the one or more related content items from the computer network;
determining whether the deviation between the value of the content attribute for the content item and the one or more current values of the content attribute for the one or more related content items exceeds the one or more thresholds defined by the one or more synchronization constraints; and
updating the value of the content attribute based at least in part on a determination that the deviation between the value of the content attribute for the content item and the one or more current values of the content attribute for the one or more related content items exceeds the one or more thresholds defined by the one or more synchronization constraints.

7. The method of claim 6, wherein updating the value of the content attribute based at least in part on a determination that the deviation between the value of the content attribute for the content item and the one or more current values of the content attribute for the one or more related content items exceeds the one or more thresholds defined by the one or more synchronization constraints comprises:
modifying the value of the content attribute to fall within a threshold range of an average value of the content attribute for the one or more related content items.

8. The method of claim 1, wherein the one or more nodes comprise one or more of:
a web server, a file server, an application server, a file transfer protocol (FTP) server, a mail server, a database server, a media server, an e-commerce server, a directory server, a content hosting website, a content publisher website, or a content provider website.

9. The method of claim 1, further comprising:
monitoring network activity corresponding to the content item on the computer network over a subsequent time period;
updating the multidimensional content vector corresponding to the content item based at least in part on the monitored network activity; and
determining a second updated value of the content attribute for the content item by applying the attribute determination model to the updated multidimensional content vector corresponding to the content item.

10. The method of claim 9, wherein updating the multidimensional content vector corresponding to the content item based at least in part on the monitored network activity comprises:
detecting network activity corresponding to the content item on the computer network;
updating one or more content consumption attributes corresponding to the content item based at least in part on the detected network activity; and
generating a new multidimensional content vector corresponding to the content item based at least in part on the updated one or more content consumption attributes.

11. A reinforcement learning agent apparatus for optimizing a current value of a content attribute, the apparatus comprising:
one or more processors; and
one or more memories operatively coupled to at least one of the one or more processors and having instructions stored thereon that, when executed by at least one of the one or more processors, cause at least one of the one or more processors to:
determine a value of a content attribute for a content item on a computer network by applying an attribute determination model to a multidimensional content vector corresponding to the content item, the attribute determination model being configured to determine the value of the content attribute;
apply a synchronization function comprising one or more synchronization constraints to update the value of the content attribute, the synchronization function being configured to identify one or more related content items on the computer network and update the value of the content attribute to constrain any deviation between the value of the content attribute for the content item and one or more current values of the content attribute for the one or more related content items to within one or more thresholds defined by the one or more synchronization constraints; and
transmit one or more instructions configured to designate the updated value as a current value of the content attribute for the content item on one or more nodes of the computer network.

12. The apparatus of claim 11, wherein the synchronization function is configured to identify one or more related content items on the computer network based at least in part on one or more vector similarity measures between the multidimensional content vector corresponding to the content item and one or more multidimensional content vectors corresponding to the one or more related content items.

13. The apparatus of claim 11, wherein the multidimensional content vector comprises a plurality of feature values corresponding to a plurality of features relating to the content item.

14. The apparatus of claim 13, wherein the plurality of features comprise one or more of: content publisher, content provider, content language, content format, content category, content quality, content originality, content bias, content topic engagement, content rating, content seasonality, content value analysis, content user engagement, content domain performance, content user journey analysis, content time spent, content valuation trends, content initial price, content price forecast, content engagement correlation, content return on investment, content performance by language and domain, or content user engagement and valuation forecast.

15. The apparatus of claim 11, wherein the attribute determination model is configured to maximize a utility function and minimize a penalty function and wherein the utility function is derived based at least in part on the content attribute and wherein the penalty function penalizes differences between the determined content attribute value and a reward function content attribute value determined based on a reward function.

16. The apparatus of claim 11, wherein the instructions that, when executed by at least one of the one or more processors, cause at least one of the one or more processors to apply a synchronization function comprising one or more synchronization constraints to update the value of the content attribute further cause at least one of the one or more processors to:
identify one or more related content items on the computer network based at least in part on one or more vector similarity measures between the multidimensional content vector corresponding to the content item and one or more multidimensional content vectors corresponding to the one or more related content items;
retrieve one or more current values of the content attribute for the one or more related content items from the computer network;
determine whether the deviation between the value of the content attribute for the content item and the one or more current values of the content attribute for the one or more related content items exceeds the one or more thresholds defined by the one or more synchronization constraints; and
update the value of the content attribute based at least in part on a determination that the deviation between the value of the content attribute for the content item and the one or more current values of the content attribute for the one or more related content items exceeds the one or more thresholds defined by the one or more synchronization constraints.

17. The apparatus of claim 16, wherein the instructions that, when executed by at least one of the one or more processors, cause at least one of the one or more processors to update the value of the content attribute based at least in part on a determination that the deviation between the value of the content attribute for the content item and the one or more current values of the content attribute for the one or more related content items exceeds the one or more thresholds defined by the one or more synchronization constraints further cause at least one of the one or more processors to:
modify the value of the content attribute to fall within a threshold range of an average value of the content attribute for the one or more related content items.

18. The apparatus of claim 11, wherein the computer network comprises one or more of:
a web server, a file server, an application server, a file transfer protocol (FTP) server, a mail server, a database server, a media server, an e-commerce server, a directory server, a content hosting website, a content publisher website, or a content provider website.

19. The apparatus of claim 11, wherein at least one of the one or more memories has further instructions stored thereon that, when executed by at least one of the one or more processors, cause at least one of the one or more processors to:
monitor network activity corresponding to the content item on the computer network over a subsequent time period;
update the multidimensional content vector corresponding to the content item based at least in part on the monitored network activity; and
determine a second updated value of the content attribute for the content item by applying the attribute determination model to the updated multidimensional content vector corresponding to the content item.

20. The apparatus of claim 19, wherein the instructions that, when executed by at least one of the one or more processors, cause at least one of the one or more processors to update the multidimensional content vector corresponding to the content item based at least in part on the monitored network activity further cause at least one of the one or more processors to:
detect network activity corresponding to the content item on the computer network;
update one or more content consumption attributes corresponding to the content item based at least in part on the detected network activity; and
generate a new multidimensional content vector corresponding to the content item based at least in part on the updated one or more content consumption attributes.

21. At least one non-transitory computer-readable medium storing computer-readable instructions for optimizing a current value of a content attribute that, when executed by one or more computing devices of a reinforcement learning agent, cause at least one of the one or more computing devices to:
determine a value of a content attribute for a content item on a computer network by applying an attribute determination model to a multidimensional content vector corresponding to the content item, the attribute determination model being configured to determine the value of the content attribute;
apply a synchronization function comprising one or more synchronization constraints to update the value of the content attribute, the synchronization function being configured to identify one or more related content items on the computer network and update the value of the content attribute to constrain any deviation between the value of the content attribute for the content item and one or more current values of the content attribute for the one or more related content items to within one or more thresholds defined by the one or more synchronization constraints; and
transmit one or more instructions configured to designate the updated value as a current value of the content attribute for the content item on one or more nodes of the computer network.

22. The at least one non-transitory computer-readable medium of claim 21, wherein the synchronization function is configured to identify one or more related content items on the computer network based at least in part on one or more vector similarity measures between the multidimensional content vector corresponding to the content item and one or more multidimensional content vectors corresponding to the one or more related content items.

23. The at least one non-transitory computer-readable medium of claim 21, wherein the multidimensional content vector comprises a plurality of feature values corresponding to a plurality of features relating to the content item.

24. The at least one non-transitory computer-readable medium of claim 23, wherein the plurality of features comprise one or more of: content publisher, content provider, content language, content format, content category, content quality, content originality, content bias, content topic engagement, content rating, content seasonality, content value analysis, content user engagement, content domain performance, content user journey analysis, content time spent, content valuation trends, content initial price, content price forecast, content engagement correlation, content return on investment, content performance by language and domain, or content user engagement and valuation forecast.

25. The at least one non-transitory computer-readable medium of claim 21, wherein the attribute determination model is configured to maximize a utility function and minimize a penalty function and wherein the utility function is derived based at least in part on the content attribute and wherein the penalty function penalizes differences between the determined content attribute value and a reward function content attribute value determined based on a reward function.

26. The at least one non-transitory computer-readable medium of claim 21, wherein the instructions that, when executed by at least one of the one or more computing devices, cause at least one of the one or more computing devices to apply a synchronization function comprising one or more synchronization constraints to update the value of the content attribute further cause at least one of the one or more computing devices to:
identify one or more related content items on the computer network based at least in part on one or more vector similarity measures between the multidimensional content vector corresponding to the content item and one or more multidimensional content vectors corresponding to the one or more related content items;
retrieve one or more current values of the content attribute for the one or more related content items from the computer network;
determine whether the deviation between the value of the content attribute for the content item and the one or more current values of the content attribute for the one or more related content items exceeds the one or more thresholds defined by the one or more synchronization constraints; and
update the value of the content attribute based at least in part on a determination that the deviation between the value of the content attribute for the content item and the one or more current values of the content attribute for the one or more related content items exceeds the one or more thresholds defined by the one or more synchronization constraints.

27. The at least one non-transitory computer-readable medium of claim 26, wherein the instructions that, when executed by at least one of the one or more computing devices, cause at least one of the one or more computing devices to update the value of the content attribute based at least in part on a determination that the deviation between the value of the content attribute for the content item and the one or more current values of the content attribute for the one or more related content items exceeds the one or more thresholds defined by the one or more synchronization constraints further cause at least one of the one or more computing devices to:
modify the value of the content attribute to fall within a threshold range of an average value of the content attribute for the one or more related content items.

28. The at least one non-transitory computer-readable medium of claim 21, wherein the computer network comprises one or more of:
a web server, a file server, an application server, a file transfer protocol (FTP) server, a mail server, a database server, a media server, an e-commerce server, a directory server, a content hosting website, a content publisher website, or a content provider website.

29. The at least one non-transitory computer-readable medium of claim 21, further storing computer-readable instructions that, when executed by at least one of the one or more computing devices, cause at least one of the one or more computing devices to:
monitor network activity corresponding to the content item on the computer network over a subsequent time period;
update the multidimensional content vector corresponding to the content item based at least in part on the monitored network activity; and
determine a second updated value of the content attribute for the content item by applying the attribute determination model to the updated multidimensional content vector corresponding to the content item.

30. The at least one non-transitory computer-readable medium of claim 29, wherein the instructions that, when executed by at least one of the one or more computing devices, cause at least one of the one or more computing devices to update the multidimensional content vector corresponding to the content item based at least in part on the monitored network activity further cause at least one of the one or more computing devices to:
detect network activity corresponding to the content item on the computer network;
update one or more content consumption attributes corresponding to the content item based at least in part on the detected network activity; and
generate a new multidimensional content vector corresponding to the content item based at least in part on the updated one or more content consumption attributes.
